(19) United States
(12) Patent Application Publication
(10) Pub. No.: US 2026/0332758 A1
(43) Pub. Date: Oct. 22, 2026

(54) FILTERING METHOD AND APPARATUS, ELECTRONIC DEVICE, AND STORAGE MEDIUM

(71) Applicant: Tencent Technology (Shenzhen) Company Limited, Shenzhen (CN)

(72) Inventors: Renjie CHANG, Shenzhen (CN); Liqiang WANG, Shenzhen (CN)

(21) Appl. No.: 19/468,852

(22) Filed: Feb. 3, 2026

Related U.S. Application Data
(63) Continuation of application No. PCT/CN2024/109312, filed on Aug. 1, 2024.

(30) Foreign Application Priority Data
Nov. 9, 2023 (CN) 202311497940.1

(51) Int. Cl. H04N 19/117; H04N 19/105; H04N 19/172; H04N 19/176; H04N 19/42; H04N 19/46

(52) U.S. Cl. CPC H04N 19/117; H04N 19/105; H04N 19/172; H04N 19/176; H04N 19/42; H04N 19/46

(57) ABSTRACT

This application provide a filtering method performed by an electronic device. The method includes: obtaining a first to-be-filtered unit obtained through decoding; determining at least one reference picture in a reference picture set, the reference picture set including at least one of the following: a reference picture in a reference picture list of the first to-be-filtered unit, and a to-be-filtered picture to which the first to-be-filtered unit belongs; and filtering the first to-be-filtered unit by using a neural network filter based on first information associated with the first to-be-filtered unit and the at least one reference picture, to obtain a filtered unit. In this application, a selection range of reference pictures is enriched to improve filtering performance of the neural network filter, so that filtering effect of the to-be-filtered picture can be improved.

### CROSS-REFERENCE TO RELATED APPLICATIONS

This application is a continuation application of PCT Patent Application No. PCT/CN2024/109312, entitled “FILTERING METHOD AND APPARATUS, ELECTRONIC DEVICE, AND STORAGE MEDIUM” filed on Aug. 1, 2024, which claims priority to Chinese Patent Application No. 2023114979401, entitled “FILTERING METHOD AND APPARATUS, ELECTRONIC DEVICE, AND STORAGE MEDIUM” filed with the China National Intellectual Property Administration on Nov. 9, 2023, all of which are incorporated herein by reference in their entirety.

### FIELD OF THE TECHNOLOGY

This application relates to the field of video coding and decoding technologies, and in particular, to a filtering method and apparatus, an electronic device, and a storage medium.

### BACKGROUND OF THE DISCLOSURE

With development of video technologies, a large amount of data is included in video data. To facilitate transmission of the video data, a video apparatus performs a video compression technology to more efficiently transmit or store the video data. During the video compression, a coder and a decoder each need to perform operations such as inverse quantization and inverse transformation to obtain a reconstructed picture. Because a loss occurs during the video compression, after the reconstructed picture is obtained, the reconstructed picture further needs to be filtered to reduce a compression loss of the reconstructed picture.

Usually, the reconstructed picture may be filtered by using a deblocking filter (DBF) technology, a sample adaptive offset (SAO) technology, an adaptive loop filter (ALF) technology, or the like.

However, with development of technologies, a better filtering technology still needs to be found to improve filtering effect.

### SUMMARY

Embodiments of this application provide a filtering method and apparatus, an electronic device, and a storage medium, to improve filtering effect.

According to a first aspect, embodiments of this application provide a filtering method performed by an electronic device acting as a decoding device. The method includes:
obtaining a first to-be-filtered unit obtained through decoding, and the first to-be-filtered unit including a to-be-filtered picture or a to-be-filtered picture block;
determining at least one reference picture in a reference picture set, the reference picture set including at least one of the following: a reference picture in a reference picture list of the first to-be-filtered unit, and a to-be-filtered picture to which the first to-be-filtered unit belongs; and
filtering the first to-be-filtered unit by using a neural network filter based on first information associated with the first to-be-filtered unit and the at least one reference picture, to obtain a filtered unit.

According to a second aspect, embodiments of this application provide a filtering method performed by an electronic device acting as a coding device. The method includes:
obtaining a first to-be-filtered unit obtained through decoding, and the first to-be-filtered unit including a to-be-filtered picture or a to-be-filtered picture block;
determining at least one reference picture in a reference picture set, the reference picture set including at least one of the following: a reference picture in a reference picture list of the first to-be-filtered unit, and a to-be-filtered picture to which the first to-be-filtered unit belongs; and
filtering the first to-be-filtered unit by using the neural network filter based on the first to-be-filtered information and the at least one reference picture, to obtain a filtered unit.

According to a third aspect, this application provides an electronic device, including a memory, a processor, and a computer program stored in the memory and capable of running on the processor, the processor implementing the filtering method in the first aspect or the filtering method in the second aspect when executing the program.

According to a fourth aspect, embodiments of this application provide a non-transitory computer-readable storage medium, the computer-readable storage medium having computer instructions therein, and when the computer instructions are read and executed by a processor of a computer device, the computer device being enabled to perform the filtering method in the first aspect or the filtering method in the second aspect.

According to a fifth aspect, embodiments of this application provide a code stream. The code stream may be a code stream decoded by using the filtering method in the first aspect, or the code stream may be a code stream generated by using the filtering method in the second aspect.

According to the filtering method provided in this application, during decoding, a decoder obtains first to-be-filtered information. The first to-be-filtered information includes a first to-be-filtered unit obtained through decoding. The first to-be-filtered unit may be a unit of any type or any size that is obtained through decoding by the decoder and that needs to be filtered, and may include a picture, a picture block, an audio block, or another basic unit for signal processing. Then, if determining to filter the first to-be-filtered unit by using a neural network filter, the decoder determines at least one reference picture in a reference picture set, the reference picture set including at least one of the following: a reference picture in a reference picture list of the first to-be-filtered unit, and a to-be-filtered picture to which the first to-be-filtered unit belongs; and then filters the first to-be-filtered unit by using the neural network filter based on the first to-be-filtered information and the at least one reference picture, to obtain a filtered unit of the first to-be-filtered unit. To be specific, when the first to-be-filtered unit in the first to-be-filtered information is filtered by using the neural network filter, the at least one reference picture in the reference picture set needs to be determined first, and then the first to-be-filtered unit is filtered by using the neural network filter based on the first to-be-filtered information and the at least one reference picture, to obtain the filtered unit of the first to-be-filtered unit. The reference picture set includes at least one of the following: the reference picture in the reference picture list of the first to-be-filtered unit, and the to-be-filtered picture to which the first to-be-filtered unit belongs. In addition, the reference picture in the reference picture list of the first to-be-filtered unit can provide time-domain information for the first to-be-filtered unit, and the to-be-filtered picture to which the first to-be-filtered unit belongs may provide spatial-domain information for the first to-be-filtered unit. Therefore, filtering the first to-be-filtered unit by using the neural network filter based on the first to-be-filtered information and the at least one reference picture is equivalent to using at least one of the time-domain information and the spatial-domain information to assist the neural network filter in filtering the first to-be-filtered unit. That is, a selection range of reference pictures is enriched to improve filtering performance of the neural network filter, so that filtering effect of the to-be-filtered picture can be improved.

### BRIEF DESCRIPTION OF THE DRAWINGS

FIG. 1 is a schematic block diagram of a video coding and decoding system according to an embodiment of this application.

FIG. 2 is a schematic block diagram of a video coder according to an embodiment of this application.

FIG. 3 is a schematic structural diagram of a relationship between a coding tree unit (CTU) and a coding unit (CU) according to an embodiment of this application.

FIG. 4 is a schematic block diagram of a video decoder according to an embodiment of this application.

FIG. 5 shows another example of a video coder according to an embodiment of this application.

FIG. 6 is a schematic structural diagram of a CTU according to this application.

FIG. 7 is a schematic diagram of a filtering principle of a neural network in-loop filter (NNLF) according to an embodiment of this application.

FIG. 8 is a schematic diagram of a filtering principle of a temporal NNLF according to this application.

FIG. 9 is a schematic flowchart of a filtering method according to an embodiment of this application.

FIG. 10 shows an example of a to-be-filtered picture block according to an embodiment of this application.

FIG. 11 shows an example of at least one reference picture according to an embodiment of this application.

FIG. 12 shows another example of at least one reference picture according to an embodiment of this application.

FIG. 13 is another schematic flowchart of a filtering method according to an embodiment of this application.

FIG. 14 is a schematic block diagram of a filtering apparatus according to an embodiment of this application.

FIG. 15 is another schematic block diagram of a filtering apparatus according to an embodiment of this application.

FIG. 16 is a schematic block diagram of an electronic device according to an embodiment of this application.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are only some of the embodiments provided in this application rather than all of the embodiments. All other embodiments obtained by a person of ordinary skill in the art based on the embodiments of this application without creative efforts shall fall within the protection scope of this application.

For ease of understanding the technical solutions provided in this application, related terms are described below.

Terms used in the implementations of this application are merely intended for explaining the embodiments of this application but not to limit this application.

For example, the term “and/or” in this specification describes only an association relationship for describing associated objects and indicates that three relationships may exist. For example, A and/or B may indicate the following three cases: Only A exists, both A and B exist, and only B exists. The term “at least one of” describes only a combination relationship of listed objects and indicates that one or more items may exist. For example, “at least one of the following: A, B, and C” may indicate the following combination cases: Only A exists, only B exists, only C exists, both A and B exist, both A and C exist, both B and C exist, and all of A, B, and C exist. The term “a plurality of” indicates two or more. The character “/” usually indicates an “or” relationship between associated objects.

For another example, the term “corresponding to” may indicate a direct correspondence or an indirect correspondence between two objects, or may indicate an association relationship between two objects, or may indicate a relationship of indicating and being indicated, or a relationship of configuring and being configured. The term “indicate” may indicate a direct indication, an indirect indication, or an association relationship. For example, that A indicates B may indicate that A directly indicates B, for example, B may be obtained by using A; or may indicate that A indirectly indicates B, for example, A indicates C, and B may be obtained by using C; or may indicate that A and B have an association relationship. The term “predefine” or “preconfigure” may indicate that corresponding code, tables, or other related information that can be used for indication may be prestored on a device, or may be agreed upon in a protocol. The “protocol” may be a standard protocol in the art. The term “when” may be interpreted as “in a case that”, “if”, “during”, “in response to”, or similar descriptions. Similarly, depending on the context, the phrase “if determining” or “if detecting (a stated condition or event)” may be interpreted as “when determining”, “in response to determining”, “when detecting (the stated condition or event)”, “in response to detecting (the stated condition or event)”, or similar descriptions. The terms “first”, “second”, “third”, “fourth”, “A^{th}”, “B^{th}”, and the like are intended to distinguish between different objects, but not to describe a specific sequence. The terms “include”, “have”, and any variants thereof are intended to cover a non-exclusive inclusion. A digital video compression technology is mainly to compress massive digital picture and video data for transmission, storage, and the like.

The solutions provided in this application relate to the field of digital compression technologies.

The digital video compression technology is mainly to compress massive digital picture and video data for transmission, storage, and the like.

The solutions provided in this application may be applied to the field of digital video coding technologies.

The field of digital video coding technologies includes but is not limited to at least one of the following: the field of picture coding and decoding, the field of video coding and decoding, the field of hardware video coding and decoding, the field of dedicated circuit video coding and decoding, and the field of real-time video coding and decoding. In addition, the solutions provided in this application may be combined with the following standards: an audio video coding standard (AVS), a second-generation AVS standard (AVS2), or a third-generation AVS standard (AVS3), for example, including but not limited to an H.264/audio video coding (AVC) standard, an H.265/high efficiency video coding (HEVC) standard, and an H.266/versatile video coding (VVC) standard. In addition, the solutions provided in this application may be configured for performing lossy compression on a picture, or may be configured for performing lossless compression on a picture. The lossless compression may be visually lossless compression, or may be mathematically lossless compression.

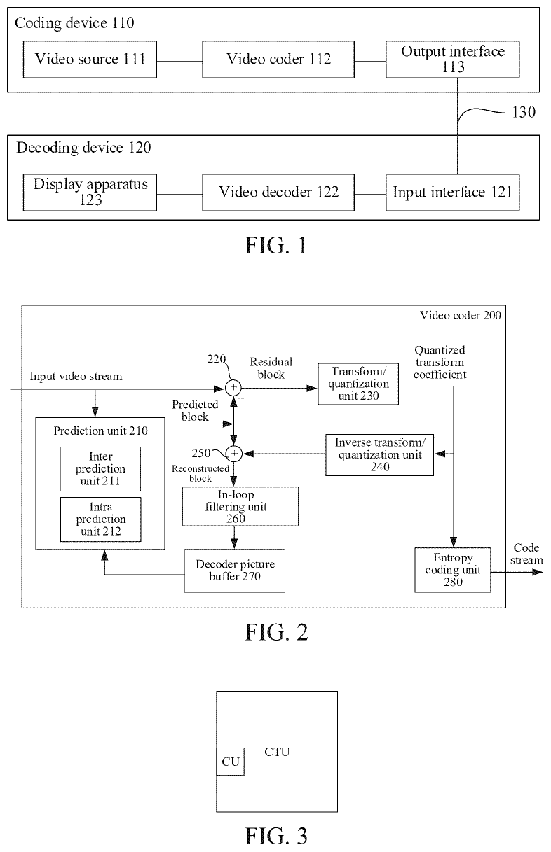

For ease of understanding, a video coding and decoding system in the embodiments of this application is first described with reference to FIG. 1.

FIG. 1 is a schematic block diagram of a video coding and decoding system according to an embodiment of this application.

As shown in FIG. 1, the video coding and decoding system 100 includes a coding device 110 and a decoding device 120.

The coding device 110 is configured to code (which may be understood as compressing) video data to generate a code stream, and transmit the code stream to the decoding device 120. The decoding device 120 decodes the code stream generated by the coding device 110 through coding, to obtain decoded video data.

The coding device 110 may be understood as a device with a video coding function, and the decoding device 120 may be understood as a device with a video decoding function. To be specific, in this embodiment of this application, the coding device 110 and the decoding device 120 include a wider range of apparatuses, for example, include a smartphone, a desktop computer, a mobile computing apparatus, a notebook (for example, laptop) computer, a tablet computer, a set-top box, a television, a camera, a display apparatus, a digital media player, a video game console, and an in-vehicle computer.

The coding device 110 may transmit coded video data (for example, a code stream) to the decoding device 120 through a channel 130.

The channel 130 may include one or more media and/or apparatuses capable of transmitting the coded video data from the coding device 110 to the decoding device 120.

The channel 130 may include one or more communication media enabling the coding device 110 to directly transmit the coded video data to the decoding device 120 in real time. The coding device 110 may modulate the coded video data according to a communication standard and transmit modulated video data to the decoding device 120. The communication medium includes a wireless communication medium, for example, a radio frequency spectrum. The communication medium may further include a wired communication medium, for example, one or more physical transmission lines.

The channel 130 may include a storage medium. The storage medium may store video data coded by the coding device 110. The storage medium includes a plurality of types of local access data storage media, for example, a compact disc, a DVD, and a flash memory. In this example, the decoding device 120 may obtain the coded video data from the storage medium.

The channel 130 may include a storage server. The storage server may store the video data coded by the coding device 110. In this example, the decoding device 120 may download the stored coded video data from the storage server. In some embodiments, the storage server may store the coded video data and may transmit the coded video data to the decoding device 120, for example, a web server (for example, for a website) or a file transfer protocol (FTP) server.

The coding device 110 includes a video coder 112 and an output interface 113.

The output interface 113 may include a modulator/demodulator (modem) and/or a transmitter. The video coder 112 directly transmits the coded video data to the decoding device 120 through the output interface 113. The coded video data may be further stored in the storage medium or on the storage server, to be subsequently read by the decoding device 120.

In addition to the video coder 112 and the input interface 113, the coding device 110 may further include a video source 111.

The video source 111 may include at least one of a video capture apparatus (for example, a video camera), a video archive, a video input interface, and a computer graphics system. The video input interface is configured to receive video data from a video content provider. The computer graphics system is configured to generate video data. The video coder 112 codes video data from the video source 111, to generate a code stream. The video data may include one or more pictures or a sequence of pictures. The code stream includes coded information of the picture or the sequence of pictures in a form of a bitstream. The coded information may include coded picture data and associated data. The associated data may include a sequence parameter set (SPS), a picture parameter set (PPS), and another syntax structure. The SPS may include parameters applied to one or more sequences. The PPS may include parameters applied to one or more pictures. The syntax structure is a set of zero or more syntax elements arranged in a specified order in the code stream.

The decoding device 120 includes an input interface 121 and a video decoder 122. The input interface 121 may include a receiver and/or a modem.

In addition to the input interface 121 and the video decoder 122, the decoding device 120 may further include a display apparatus 123.

The input interface 121 may receive the coded video data through the channel 130. The video decoder 122 is configured to decode the coded video data to obtain decoded video data, and transmit the decoded video data to the display apparatus 123. The display apparatus 123 displays the decoded video data. The display apparatus 123 may be integrated with the decoding device 120 or external to the decoding device 120. The display apparatus 123 may include a plurality of types of display apparatuses, for example, a liquid crystal display (LCD), a plasma display, an organic light-emitting diode (OLED) display, or another type of display apparatus.

FIG. 1 is merely an example of this application, and is not construed as a limitation on this application. To be specific, the technical solutions in the embodiments of this application are not limited to the system framework shown FIG. 1. For example, the technology of this application may be further applied to single-side video coding or single-side video decoding.

A video coding framework in the embodiments of this application is described below.

FIG. 2 is a schematic block diagram of a video coder 200 according to an embodiment of this application.

The video coder 200 may be applied to picture data in a luminance and chrominance (YCbCr, YUV) format. For example, a YUV ratio may be 4:2:0, 4:2:2, or 4:4:4, where Y represents luminance, Cb (U) represents blue chrominance, Cr (V) represents red chrominance, and U and V represent chrominance for describing colors and saturation. For example, in a color format, 4:2:0 indicates that every four pixels have four luminance components and two chrominance components (YYYYCbCr), 4:2:2 indicates that every four pixels have four luminance components and four chrominance components (YYYYCbCrCbCr), and 4:4:4 indicates full pixel display (YYYYCbCrCbCrCbCrCbCr). Certainly, the video coder 200 may alternatively be applied to picture data in a red-green-blue (RGB) format. This is not specifically limited in this application.

After reading a video stream, the video coder 200 may divide each frame of picture in the video stream into several CTUs. In some examples, the CTU may be referred to as a tree block, a largest coding unit (LCU), or a coding tree block (CTB). A size of one CTU may be, for example, 128×128, 64×64, or 32×32.

FIG. 3 is a schematic structural diagram of a relationship between a CTU and a CU according to an embodiment of this application.

As shown in FIG. 3, one CTU may be further divided into several CUs for coding. The CU may be a rectangular block or a square block. The CU may be further divided into a prediction unit (PU) and a transform unit (TU), so that coding, prediction, and transform are decoupled, and processing is more flexible. In an example, the CTU is divided into CUs in a tree (for example, quadtree) form, and the CU is divided into the TU and the PU in a tree (for example, quadtree) form.

The video coder and the video decoder may support various PU sizes.

Assuming that a size of a specific CU is 2N×2N, the video coder and the video decoder may support a PU size of 2N×2N or N×N for intra prediction, and support a symmetric PU of 2N×2N, 2N×N, N×2N, N×N, or a similar size for inter prediction. The video coder and the video decoder may further support asymmetric PUs of 2N×nU, 2N×nD, nL×2N, and nR×2N for inter prediction.

As shown in FIG. 2, the video coder 200 may include a prediction unit 210, a residual unit 220, a transform/quantization unit 230, an inverse transform/quantization unit 240, a reconstruction unit 250, an in-loop filtering unit 260, a decoder picture buffer (DPB) 270, and an entropy coding unit 280. The video coder 200 may include more, fewer, or different functional components. In this application, a current block may be referred to as a current CU, a current PU, or the like. A predicted block may also be referred to as a predicted picture block or a picture prediction block, and a reconstructed picture block may also be referred to as a reconstructed block or a picture reconstruction block.

The prediction unit 210 includes an inter prediction unit 211 and an intra prediction unit 212. Due to a strong correlation between adjacent pixels in a picture of a video, in a video coding and decoding technology, spatial redundancy between adjacent pixels is eliminated by using an intra prediction method. Due to a strong similarity between adjacent pictures in a video, temporal redundancy between adjacent pictures is eliminated by using an inter prediction method, to improve coding efficiency.

The inter prediction unit 211 may be configured to perform inter prediction, and may include motion estimation and motion compensation. For the inter prediction, based on picture information of different frames, a reference block may be found from a reference frame by using motion information, and a predicted block is generated based on the reference block, to eliminate the temporal redundancy. The reference frame may be a P frame and/or a B frame. The P frame is a forward predicted frame, and the B frame is a bidirectional predicted frame. For the inter prediction, after the reference block is found by using the motion information, the predicted block is generated based on the reference block. The motion information includes a frame list to which the reference frame belongs, a frame index, and a motion vector. The motion vector may be integer-pixel or fractional-pixel. If the motion vector is fractional-pixel, a needed fractional-pixel block needs to be made in the reference frame through interpolation filtering. The reference block is an integer-pixel or fractional-pixel block found based on the motion vector. In some technologies, the reference block is directly used as the predicted block. In some technologies, the predicted block is generated through further processing based on the reference block. Generating the predicted block through further processing based on the reference block may alternatively be understood as using the reference block as a predicted block and then performing processing based on the predicted block to generate a new predicted block.

The intra prediction unit 212 predicts pixel information in a current coding picture block only based on information of a same frame of picture, to eliminate the spatial redundancy. A reference frame used for the intra prediction may be an I frame.

The intra prediction includes a plurality of prediction modes. Prediction may be performed on a to-be-coded picture block in an angular prediction mode or a non-angular prediction mode to obtain a predicted block. An optimal prediction mode for the to-be-coded picture block is selected based on rate distortion information obtained through calculation by using the predicted block and the to-be-coded picture block, and the prediction mode is written to a code stream for transmission to the decoder. The decoder parses out the prediction mode, obtains a predicted block of a target decoding block through prediction, and superposes the predicted block with a time-domain residual block obtained based on the code stream, to obtain a reconstructed block.

H series international digital video coding standards are used as an example. An H.264/AVC standard has eight angular prediction modes and one non-angular prediction mode, and H.265/HEVC is extended to 33 angular prediction modes and two non-angular prediction modes. Intra prediction modes used in HEVC include a total of 35 prediction modes: a planar mode, a direct current (DC) mode, and 33 angular modes. Intra modes used in VVC include a total of 67 prediction modes: a planar mode, a DC mode, and 65 angular modes; and include a conventional prediction mode and a non-conventional prediction mode. The non-conventional prediction mode may include a matrix weighted intra prediction (MIP) mode. The conventional prediction mode includes a planar mode with a mode number 0, a DC mode with a mode number 1, and angular prediction modes with a mode number 2 to a mode number 66. With an increase in angular modes, a prediction result of the intra prediction is more accurate and better conforms to requirements for development of high-definition and ultra-high-definition digital videos. The foregoing intra prediction modes are merely examples of this application, and do not constitute a limitation on this application.

The residual unit 220 may generate a residual block of a CU based on a pixel block of the CU and a predicted block of a PU of the CU. For example, the residual unit 220 may generate the residual block of the CU, so that each sample in the residual block has a value equal to a difference between a sample in the pixel block of the CU and a corresponding sample in the predicted block of the PU of the CU.

The transform/quantization unit 230 may quantize a transform coefficient. The transform/quantization unit 230 may quantize, based on a quantization parameter (QP) value associated with the CU, a transform coefficient associated with a TU of the CU. The video coder 200 may adjust a quantization degree applied to the transform coefficient associated with the CU by adjusting the QP value associated with the CU.

The inverse transform/quantization unit 240 may apply inverse quantization and inverse transform to a quantized transform coefficient to reconstruct a residual block from the quantized transform coefficient.

The reconstruction unit 250 may add samples of the reconstructed residual block to a corresponding samples of one or more predicted blocks generated by the prediction unit 210 to generate a reconstructed picture block associated with the TU. In this manner, a sampling block of each TU of the CU is reconstructed, and the video coder 200 may reconstruct a pixel block of the CU.

The in-loop filtering unit 260 is configured to process pixels obtained through inverse transform and inverse quantization to compensate for distortion information and provide a better reference for subsequent coded pixels. For example, a deblocking filtering operation may be performed to alleviate blocking artifact of pixel blocks associated with the CU. In some embodiments, the in-loop filtering unit 260 includes a DBF unit and an SAO/ALF unit. The DBF unit is configured to eliminate blocking artifact, and the SAO/ALF unit is configured to eliminate ringing artifact.

The DPB 270 may store a reconstructed pixel block.

The inter prediction unit 211 may perform inter prediction on a PU of another picture by using a reference picture that is in the DPB 270 and that includes the reconstructed pixel block. In addition, the intra prediction unit 212 may perform intra prediction on another PU in the same picture as the CU by using the reconstructed pixel block in the DPB 270.

The entropy coding unit 280 may receive the quantized transform coefficient from the transform/quantization unit 230. The entropy coding unit 280 may perform one or more entropy coding operations on the quantized transform coefficient to generate entropy-coded data.

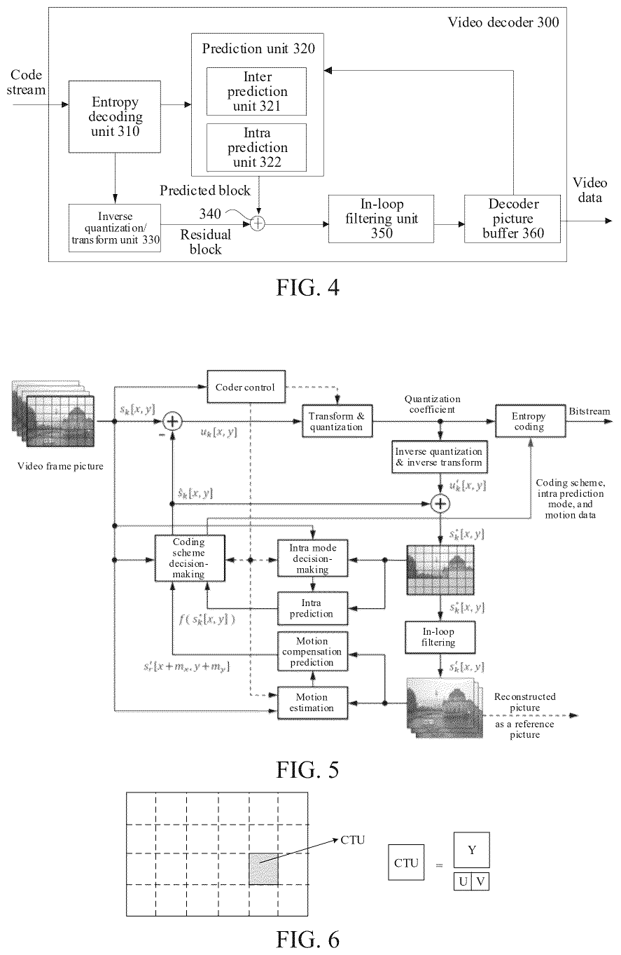

FIG. 4 is a schematic block diagram of a video decoder according to an embodiment of this application.

As shown in FIG. 4, the video decoder 300 includes an entropy decoding unit 310, a prediction unit 320, an inverse quantization/transform unit 330, a reconstruction unit 340, an in-loop filtering unit 350, and a DPB 360. The video decoder 300 may include more, fewer, or different functional components.

The video decoder 300 may receive a code stream. The entropy decoding unit 310 may parse the code stream to extract a syntax element from the code stream. As a part of parsing the code stream, the entropy decoding unit 310 may parse an entropy-coded syntax element in the code stream. The prediction unit 320, the inverse quantization/transform unit 330, the reconstruction unit 340, and the in-loop filtering unit 350 may decode video data based on the syntax element extracted from the code stream, in other words, generate decoded video data.

The prediction unit 320 includes an intra prediction unit 322 and an inter prediction unit 321.

The intra prediction unit 322 may perform intra prediction to generate a predicted block of a PU. The intra prediction unit 322 may generate the predicted block of the PU in an intra prediction mode based on a pixel block of a spatially adjacent PU. The intra prediction unit 322 may further determine the intra prediction mode for the PU based on one or more syntax elements parsed out from the code stream.

The inter prediction unit 321 may construct a first reference picture list (a list 0) and a second reference picture list (a list 1) based on the syntax element parsed out from the code stream. In addition, if the PU uses inter prediction for coding, the entropy decoding unit 310 may parse motion information of the PU. The inter prediction unit 321 may determine one or more reference blocks of the PU based on the motion information of the PU. The inter prediction unit 321 may generate a predicted block of the PU based on the one or more reference blocks of the PU.

The inverse quantization/transform unit 330 may perform inverse quantization (namely, dequantization) on a transform coefficient associated with a TU. The inverse quantization/transform unit 330 may determine a quantization degree by using a QP value associated with a CU of the TU. After performing inverse quantization on the transform coefficient, the inverse quantization/transform unit 330 may apply one or more inverse transforms to an inverse-quantized transform coefficient to generate a residual block associated with the TU.

The reconstruction unit 340 reconstructs a pixel block of the CU by using the residual block associated with the TU of the CU and the predicted block of the PU of the CU. For example, the reconstruction unit 340 may add a sample of the residual block to a corresponding sample of the predicted block to reconstruct the pixel block of the CU, to obtain a reconstructed picture block.

The in-loop filtering unit 350 may perform a deblocking filtering operation to alleviate blocking artifact of pixel blocks associated with the CU.

The video decoder 300 may store a reconstructed picture of the CU in the DPB 360. The video decoder 300 may use the reconstructed picture in the DPB 360 as a reference picture for subsequent prediction, or transmit the reconstructed picture to a display apparatus for display.

With reference to FIG. 2 and FIG. 4, a basic process of video coding and decoding is as follows:

On the coder side, a frame of picture is divided into picture blocks, and for a current block, the prediction unit 210 generates a predicted block of the current block (namely, a to-be-coded block) through intra prediction or inter prediction. The residual unit 220 may calculate, based on the predicted block and an original block of the current block (namely, the to-be-coded block), a residual block, that is, a difference between the predicted block and the original block of the current block. The residual block may also be referred to as residual information. The residual block is transformed and quantized by the transform/quantization unit 230 to remove information insensitive to human eyes, to eliminate visual redundancy. In some embodiments, a residual block before being transformed and quantized by the transform/quantization unit 230 may be referred to as a time-domain residual block, and a time-domain residual block after being transformed and quantized by the transform/quantization unit 230 may be referred to as a frequency residual block or a frequency-domain residual block. The entropy coding unit 280 receives a quantized transform coefficient outputted by the transform/quantization unit 230, and may perform entropy coding on the quantized transform coefficient and output a code stream. For example, the entropy coding unit 280 may eliminate character redundancy based on a target context model and probability information of a binary code stream.

On the decoder side, the entropy decoding unit 310 may parse a code stream to obtain prediction information, a quantization coefficient matrix, and the like of a current block (namely, a to-be-decoded block). The prediction unit 320 predicts a predicted block of the current block (namely, the to-be-decoded block) based on the prediction information through intra prediction or inter prediction. The inverse quantization/transform unit 330 performs, by using the quantization coefficient matrix obtained from the code stream, inverse quantization and inverse transform on the quantization coefficient matrix to obtain a residual block. The reconstruction unit 340 adds the predicted block to the residual block to obtain a reconstructed block. The reconstructed block forms a reconstructed picture, and the in-loop filtering unit 350 performs in-loop filtering on the reconstructed picture based on the picture or the block to obtain a decoded picture. The coder side also needs to perform an operation similar to that of the decoder side to obtain a decoded picture. The decoded picture may also be referred to as a reconstructed picture, and the reconstructed picture may be a subsequent picture used as a reference picture for inter prediction.

Block partition information determined by the coder, and mode information or parameter information of prediction, transform, quantization, entropy coding, in-loop filtering, and the like are carried in the code stream when necessary. The decoder parses the code stream and analyzes the code stream based on existing information to determine block partition information, and mode information or parameter information of prediction, transform, quantization, entropy coding, in-loop filtering, and the like that are the same as those of the coder side, to ensure that the decoded picture obtained by the coder is the same as the decoded picture obtained by the decoder.

Due to a requirement of parallel processing, a picture may be divided into slices or the like, and slices in a same picture may be processed in parallel, in other words, there is no data dependency between the slices. The term “frame” may be understood as a picture, a slice, or the like.

In addition, the foregoing describes a basic process of a video codec in a block-based coding and decoding framework. With development of technologies, some modules or operations of the framework or the process may be optimized. In other words, this application is not limited to the framework or the process.

FIG. 5 shows another example of a video coder according to this application.

As shown in FIG. 5, a difference operation is performed on an original picture signal sₖ[x, y] and a predicted picture signal ŝₖ[x, y] to obtain a residual signal uₖ[x, y], the residual signal uₖ[x, y] is transformed and quantized to obtain a quantization coefficient, the quantization coefficient is entropy-coded to obtain a coded bitstream and is inverse-quantized and inverse-transformed to obtain a reconstructed residual signal u′ₖ[x, y], and the predicted picture signal ŝₖ[x, y] and the reconstructed residual signal u′ₖ[x, y] are superposed to generate a reconstructed picture signal

$${S}_{k}^{*} [ x , y ] .$$

The reconstructed picture signal

$${S}_{k}^{*} [ x , y ]$$

is inputted to an intra mode decision-making module and an intra prediction module to perform intra prediction, and is also filtered through in-loop filtering to output a filtered picture signal s′ₖ[x, y]. The filtered picture signal s′ₖ[x, y] may be used as a reference picture for a next frame, and is configured for performing motion estimation and motion compensation prediction on the next frame. Further, prediction may be performed on the next frame based on a motion compensation prediction result s′ᵣ[x+mₓ, y+m_{y}] and an intra prediction result

$$f ( {S}_{k}^{*} [ x , y ] )$$

to obtain a predicted picture signal ŝₖ[x, y] of the next frame, and the foregoing process may be further repeated until coding is completed.

For ease of understanding the technical solutions provided in this application, related content is described below.

### (1) a Video Coding Technology is Briefly Described.

From the perspective of a signal obtaining manner, a video signal may be obtained in two manners: captured by a camera and generated by a computer. Different statistical characteristics may correspond to different compression and coding modes.

International video coding standards HEVC and VVC and the China national video coding standard AVS are used as an example. A hybrid coding framework is used. In the hybrid coding framework, a series of operations and processing below may be performed on an inputted original video signal:

### 1. Block Partition Structure

An input picture is divided into several non-overlapping processing units based on a size of one processing unit, and similar compression operations are performed on all of the processing units. The processing unit is referred to as a CTU or an LCU. Further, the CTU may be divided in a more fine-grained manner to obtain one or more basic coding units that are referred to as CUs. Each CU is a most basic element in a coding process. The following describes various coding modes that may be used for each CU.

### 2. Predictive Coding

The predictive coding includes intra prediction, inter prediction, and the like. The original video signal undergoes prediction based on a selected reconstructed video signal to obtain a residual video signal. A coder side selects a most appropriate one of a plurality of possible predictive coding modes for a current CU, and notifies a decoder.

a. Intra prediction: a signal for prediction is from an area that has been coded and reconstructed and that is in a same picture. A frame coded through intra prediction is an I frame. The I frame is also referred to as an intra coded frame.

b. Inter prediction: a signal for prediction is from another picture (referred to as a reference picture) that has been coded and that is different from a current picture. A frame coded through inter prediction is a P frame and a B frame. In other words, the P frame is a picture coded only by using a unidirectional reference frame, and the B frame is a picture coded by using a bidirectional (forward and backward) reference frame. The P frame is also referred to as a forward predictive coded frame or an inter predictive coded frame. The B frame is also referred to as a bidirectional interpolated predictive coded frame or a bidirectional predictive coded frame.

### 3. Transform and Quantization

The residual video signal undergoes transform operations such as discrete Fourier transform (DFT) and discrete cosine transform (DCT), to convert the signal into a transform domain, where the signal is referred to as a transform coefficient. The signal in the transform domain further undergoes a lossy quantization operation to remove specific information, to facilitate compression and expression of a quantized signal. In some video coding standards, a plurality of transform modes may be available for selection. Therefore, the coder side also needs to select one of the transform modes for a current CU and notify the decoder. A granularity of quantization is usually determined by a QP. A larger value of the QP indicates that coefficients in a larger value range are to be quantized into a same output, which usually corresponds to greater distortion and a lower bit rate. On the contrary, a smaller value of the QP indicates that coefficients in a smaller value range are to be quantized into a same output, which usually corresponds to smaller distortion and a higher bit rate.

### 4. Entropy Coding or Statistical Coding

A quantized transform-domain signal undergoes statistical compression and coding based on appearance frequency of each value, and a binary (0 or 1) compressed code stream is finally outputted. In addition, entropy coding also needs to be performed on other information generated through coding, such as a selected mode and a motion vector, to reduce a bit rate. The statistical coding is a lossless coding mode that can effectively reduce a bit rate needed for expressing a same signal. The statistical coding mode usually includes variable length coding (VLC) and content adaptive binary arithmetic coding (CABAC).

### 5. In-Loop Filtering

A coded picture may undergo inverse quantization, inverse transform, and predictive compensation operations to obtain a reconstructed decoded picture. Compared with an original picture, due to impact of quantization, the reconstructed picture includes some information different from that of the original picture, leading to distortion. Performing a filtering operation, for example, by using a DBF, SAO, or ALF, on the reconstructed picture can effectively reduce the distortion caused by the quantization. These filtered reconstructed pictures are to be stored in a DPB as references for subsequent coded pictures, to perform prediction on future signals. Therefore, the foregoing filtering operation is also referred to as in-loop filtering, to be specific, a filtering operation in a coding loop.

According to the foregoing coding process, after the decoder obtains a compressed code stream for each CU, the decoder first performs entropy decoding to obtain various mode information and quantized transform coefficients. The coefficients are inverse-quantized and inverse-transformed to obtain a residual signal. In addition, a predicted signal corresponding to the CU may be obtained based on known coding mode information, and the predicted signal may be added to the residual signal to obtain a reconstructed signal. Finally, a reconstructed value of the decoded picture needs to undergo an in-loop filtering operation to generate a final output signal. In this series of coding processes, the coding framework evaluates and selects an optimal coding parameter and result mainly according to a rate distortion optimization (RDO) criterion.

### (2) CTU

Each frame of picture in a video is usually first segmented into units of a specific size, and then undergoes a subsequent coding and decoding process.

FIG. 6 is a schematic structural diagram of a CTU according to this application.

As shown in FIG. 6, the CTU is a basic coding unit in the hybrid coding framework, and usually includes two parts: luminance Y and chrominance UV. To be specific, each CTU includes one luminance CTB, two chrominance CTBs, and a syntax element. For example, a picture with a YUV ratio of 4:2:0 is used as an example. The picture is divided into a plurality of CTUs. It is assumed that a size of the CTU is 16×16, the CTU includes one 16×16 luminance CTB and two 8×8 chrominance CTBs. In other words, because the picture is sampled at 4:2:0, a size of the luminance CTB is four times that of the chrominance CTB.

### (3) NNLF

Usually, in the hybrid coding framework, a conventional in-loop filter is used to suppress distortion of a reconstructed picture, to improve quality of the reconstructed picture and expect to restore a coded reconstructed picture to an original picture. However, the in-loop filter is manually designed, making it difficult to effectively alleviate the distortion of the reconstructed picture, and leaving a large optimization space. Because deep learning tools have excellent performance in picture processing, a deep learning-based in-loop filter is applied to the in-loop filter.

This application mainly relates to a technology of performing filtering by using the NNLF.

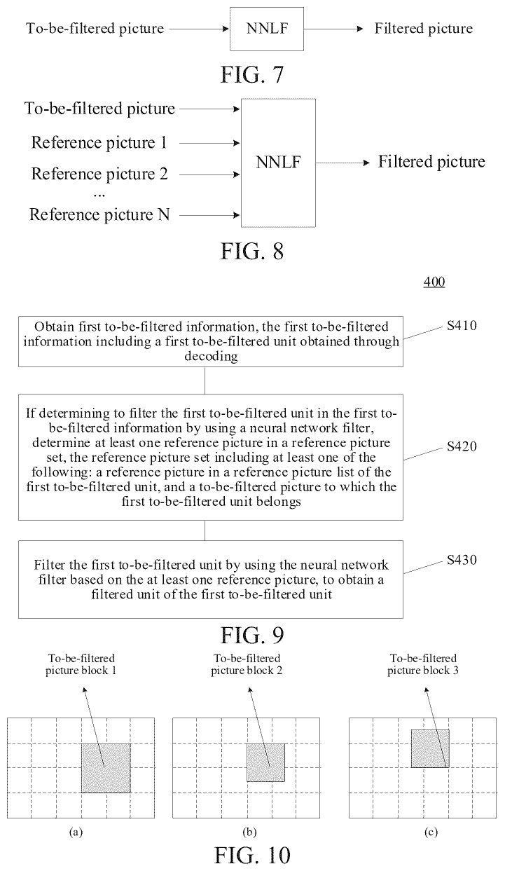

FIG. 7 is a schematic diagram of a filtering principle of an NNLF according to an embodiment of this application.

As shown in FIG. 7, a to-be-filtered picture before filtering is inputted to a trained NNLF to obtain a filtered augmented picture, namely, a filtered picture.

The NNLF usually uses a loss function to constrain the filtered picture, so that the filtered picture can be restored to an original picture as much as possible. The loss function measures a difference between a predicted value and a true value. A larger loss value of the NNLF indicates a larger difference. A training objective is to reduce the loss value of the NNLF. A common loss function for a deep learning-based coding tool includes an L1 norm loss function, an L2 norm loss function, and a smooth L1 loss function.

In addition, a temporal NNLF may be constructed by using time-domain information (for example, a reference picture).

FIG. 8 is a schematic diagram of a filtering principle of a temporal NNLF according to an embodiment of this application.

As shown in FIG. 8, a to-be-filtered picture before filtering and N reference pictures (that is, a reference picture 1 to a reference picture N) are inputted to a trained temporal NNLF to obtain a filtered augmented picture, namely, a filtered picture. Nis a positive integer greater than or equal to 1.

### (4) Picture Evaluation Indicator

The picture evaluation indicator usually includes a peak signal-to-noise ratio (PSNR) and a multi-scale structural similarity index measure (MS-SSIM).

The PNSR is a common objective criterion for evaluating a picture, and is configured for calculating a visual error between two pictures. For example, during video coding, the PSNR is configured for measuring a pixel difference between a compressed picture and an original picture. A larger value of the PNSR is better.

For example, given a denoised picture I and a noise picture K with a size of m×n, a formula for calculating a PSNR of pictures is as follows:

$$P N S R = 10 * {log}_{10} ( \frac{M A {X}^{2}}{M S E} ) .$$

MAX represents a maximum pixel value in a picture, and MSE is defined as follows:

$$MSE = \frac{1}{m n} {\sum }_{i = 0}^{m - 1} {\sum }_{j = 0}^{n - 1} {( I ( i , j ) - K ( i , j ) )}^{2} .$$

The MS-SSIM is a widely used picture quality evaluation criterion, and is configured for measuring a structural similarity between pictures, including a difference in luminance, contrast, and structure. An evaluation result of the MS-SSIM is closer to a subjective quality evaluation result of human eyes.

For example, for samples x and y, a calculation formula for the MS-SSIM is as follows:

$$MS - SSIM ( x , y ) = {[ {l}_{M} ( x , y ) ]}^{{α}_{M}} * {\prod }_{j = 1}^{M} {[ {c}_{j} ( x , y ) ]}^{{β}_{j}} * {[ {s}_{j} ( x , y ) ]}^{{γ}_{j}} .$$

cⱼ(x, y) and sⱼ(x, y) respectively represent contrast measurement and structure measurement at different scales, and l(x, y) represents luminance measurement at the last scale. α_{M}, βⱼ, and γⱼ are configured for adjusting importance of different components. M represents a quantity of scales.

A technical problem to be resolved in this application is described below.

Usually, a reference picture may be selected for the temporal NNLF as an input, to provide additional reference information for a to-be-filtered picture.

Specifically, because successive pictures of a video have a specific time-domain correlation, during video coding, a decoded picture may be used as a reference picture to provide reference for predictive coding of a current coded picture. During neural network-based video coding, a picture in a DPB may be inputted to a neural network filter, to provide effective reference for quality enhancement of a current to-be-filtered reconstructed picture.

For example, the reference picture may be selected from a reference picture list in which a plurality of decoded pictures are buffered. Specifically, for a P frame, the first picture ranked by default in a unidirectional reference picture list of the P frame may be used as a reference picture. For a B frame, the first picture ranked by default in a forward reference picture list and a backward reference picture list of the B frame may be used as a reference picture.

However, due to existence of a motion relationship, there is usually a content difference between the reference picture and the current to-be-filtered picture. Therefore, although a similar/same area in the reference picture may provide effective filtering reference for the to-be-filtered picture, a different area in the reference picture may introduce unnecessary interference or noise. In addition, a reference picture with a high quality level (a large PSNR) usually can provide more abundant information for quality enhancement of the to-be-filtered picture. On the contrary, a reference picture with a low quality level (a small PSNR) is not conducive to filtering of the to-be-filtered picture. Because all reference pictures in the DPB are compressed decoded pictures, different reference pictures have different quality levels (PSNR values). Therefore, an optimal solution of time-domain filtering cannot be obtained by directly/randomly selecting one or more pictures from the reference picture list as an input of the neural network filter.

In view of this, the embodiments of this application provide a filtering method and apparatus, an electronic device, and a storage medium, to improve filtering effect.

Specifically, the embodiments of this application provide an optimal reference picture selection method based on content characteristics and a quality level of a reference picture. An optimal reference picture in the embodiments can be adaptively selected from a reference picture set including a reference picture list and a to-be-filtered picture, and is used as an input of a neural network filter, to provide more effective reference for quality enhancement of the to-be-filtered picture, to improve filtering effect of the to-be-filtered picture and performance of neural network-based video coding.

The filtering method provided in this application is described below in detail.

The filtering method provided in this application may be applied to a video coder, a codec, or a video pre-processing or post-processing product.

For example, if the filtering method provided in this application may be applied to a video coder or a video decoder, a general-purpose neural network filter may be used as an in-loop filter (a filter output affects video coding and decoding).

If the filtering method is applied to a video coding solution, when coding a current picture, a coder side first divides the current picture into coding blocks and performs block-wise coding by using the coding block as a CU. For example, for a to-be-coded current block in the current picture, a predicted value of the current block is first obtained through inter prediction and/or intra prediction. Then, a residual value of the current block is obtained based on the predicted value of the current block and the current block. The coder side transforms the residual value of the current block to obtain a transform coefficient. In an example, the coder side does not quantize the transform coefficient of the current block, and directly codes the transform coefficient to obtain a code stream. In another example, the coder side quantizes the transform coefficient of the current block to obtain a quantized coefficient, and then codes the quantized coefficient to obtain a code stream. In addition, the coder side further performs inverse quantization (when quantization is not performed during coding, inverse quantization may alternatively not be performed) and inverse transform on the transform coefficient to obtain a residual value, and adds the residual value to the predicted value to obtain a reconstructed value of the current block. Based on the foregoing operations, reconstructed values of all coding blocks in the current picture may be obtained, and these reconstructed values form a reconstructed picture of the current picture. Then, to further improve quality of the reconstructed picture, the coder side may filter the reconstructed picture or a reconstructed picture block in the reconstructed picture by using the filtering method provided in this application, to obtain a decoded picture of the current picture. Certainly, the coder side may alternatively store the decoded picture in a decoding buffer for subsequent picture prediction.

If the filtering method is applied to a video decoding solution, for each to-be-decoded block, for example, a current block, in a current picture, after obtaining a code stream, a decoder decodes the code stream to obtain a transform coefficient of the current block. Then, the decoder performs inverse quantization (when quantization is not performed during coding, inverse quantization may alternatively not be performed) and inverse transform on the transform coefficient of the current block to obtain a residual value of the current block. In addition, the decoder obtains a predicted value of the current block through inter prediction and/or intra prediction. In this way, the predicted value and the residual value of the current block are added up to obtain a reconstructed value of the current block. Based on the foregoing operations, the decoder may determine, through decoding, reconstructed values of all to-be-decoded blocks in the current picture, and these reconstructed values form a reconstructed picture of the current picture. Then, to further improve quality of the reconstructed picture, the decoder may filter the reconstructed picture or a reconstructed picture block in the reconstructed picture by using the filtering method provided in this application, to obtain a decoded picture of the current picture. Certainly, the decoder may store the decoded picture in a decoding buffer for subsequent picture prediction. In addition, the decoder may output the decoded picture to a display device for display.

For another example, if the filtering method provided in this application may be applied to a video post-processing product, filtering optimization (a filter output does not affect video decoding) may be performed on a decoded video.

In addition, the filtering method provided in this application may also be applied to any module that uses a neural network during neural network-based video coding, for example, a neural network super-resolution module. In addition, the filtering method provided in this application may be applied not only to an inference process of neural network-based video coding, but also to a training process of a neural network filter. To be specific, one or more optimal reference pictures may be used in the training process of the neural network filter for training, and one or more optimal reference pictures are still used in a testing process for testing, to ensure consistency between the training process and the testing process, and further ensure filtering performance of the neural network filter.

FIG. 9 is a schematic flowchart of a filtering method 400 according to this application.

The filtering method 400 may be performed by a filtering apparatus. For example, the filtering method 400 may be performed by a filtering apparatus in the decoding device 120 or the decoder 122 shown in FIG. 1. For another example, the filtering method 400 may be performed by a filtering apparatus in the video decoder 300 shown in FIG. 4. For ease of description, the filtering method 400 is described below by using a decoder as an example.

As shown in FIG. 9, the filtering method 400 may include at least some or all of the following operations:
S410: The decoder obtains first to-be-filtered information, the first to-be-filtered information including a first to-be-filtered unit obtained through decoding.

For example, the first to-be-filtered unit may be a unit of any type or any size that is obtained through decoding by the decoder and that needs to be filtered, and may include a picture, a picture block, an audio block, or another basic unit for signal processing. These units are usually compressed and coded in a coding process, and the decoder needs to decode and decompress the units, and then perform subsequent processing such as filtering.

For example, the first to-be-filtered unit may be a to-be-filtered picture or a to-be-filtered picture block. The to-be-filtered picture may be a reconstructed picture, and the to-be-filtered picture block may be a partial area of the to-be-filtered picture.

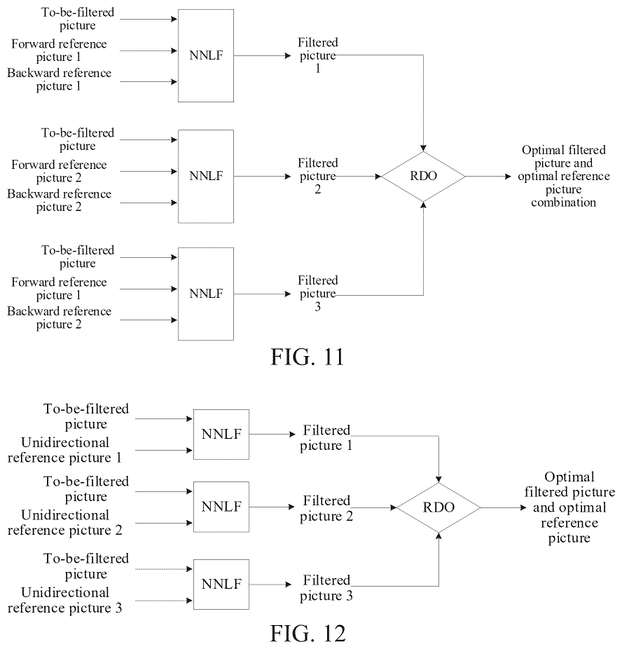

FIG. 10 shows an example of a to-be-filtered picture block according to an embodiment of this application.

As shown in FIG. 10, the to-be-filtered picture block may include L CTUs (for example, L is a positive integer) or an area of a random size. For example, as shown in (a) in FIG. 10, the to-be-filtered picture block may include four CTUs. For another example, as shown in (b) in FIG. 10, the to-be-filtered picture block may be an area whose upper left corner overlaps an upper left corner of a CTU and whose size is greater than that of one CTU. For another example, as shown in (c) in FIG. 10, the to-be-filtered picture block may be an area whose upper right corner overlaps an upper right corner of a CTU and whose size is greater than that of one CTU.
S420: If determining to filter the first to-be-filtered unit in the first to-be-filtered information by using a neural network filter, the decoder determines at least one reference picture in a reference picture set, the reference picture set including at least one of the following: a reference picture in a reference picture list of the first to-be-filtered unit, and a to-be-filtered picture to which the first to-be-filtered unit belongs.

In this embodiment of this application, if determining to filter the first to-be-filtered unit in the first to-be-filtered information by using the neural network filter, to improve filtering effect, the decoder first determines the reference picture set before filtering the first to-be-filtered unit.

The following describes a process of determining the reference picture set corresponding to the first to-be-filtered unit.

In some embodiments, the reference picture set includes the reference picture in the reference picture list of the first to-be-filtered unit. The reference picture in the reference picture list of the first to-be-filtered unit can provide time-domain information for the first to-be-filtered unit.

For example, if the to-be-filtered picture to which the first to-be-filtered unit belongs is a B frame, the reference picture list of the first to-be-filtered unit may include at least one of the following: a forward reference picture list and a backward reference picture list.

For example, if the to-be-filtered picture to which the first to-be-filtered unit belongs is a P frame, the reference picture list of the first to-be-filtered unit may include a unidirectional reference picture list, and the unidirectional reference picture list may also be referred to as a forward reference picture list.

The forward reference picture list included in the reference picture list when the to-be-filtered picture to which the first to-be-filtered unit belongs is the B frame and the forward reference picture list included in the reference picture list when the to-be-filtered picture to which the first to-be-filtered unit belongs is the P frame may be a same list, or may be lists independent of each other. This is not limited in this application.

In some embodiments, the reference picture set includes the to-be-filtered picture to which the first to-be-filtered unit belongs. In this embodiment, the to-be-filtered picture may be used as a reference picture of the first to-be-filtered unit. The to-be-filtered picture to which the first to-be-filtered unit belongs may provide spatial-domain information for the first to-be-filtered unit.

In some embodiments, the reference picture set includes the reference picture in the reference picture list of the first to-be-filtered unit, and includes the to-be-filtered picture to which the first to-be-filtered unit belongs.

For example, a quantity of the at least one reference picture included in the reference picture set may be a value agreed upon in a protocol, or may be a value notified by a coder side (for example, by using one or more flags) to the decoder.
S430: The decoder filters the first to-be-filtered unit by using the neural network filter based on the at least one reference picture, to obtain a filtered unit of the first to-be-filtered unit.

In this embodiment of this application, when filtering the first to-be-filtered unit, if determining to filter the first to-be-filtered unit by using the neural network filter, the decoder determines the reference picture set corresponding to the first to-be-filtered unit, the reference picture set including at least one of the reference picture list of the first to-be-filtered unit and the to-be-filtered picture to which the first to-be-filtered unit belongs. In this way, the decoder filters the first to-be-filtered unit by using the neural network filter based on at least one of the reference picture list of the first to-be-filtered unit and the to-be-filtered picture to which the first to-be-filtered unit belongs. This is equivalent to using at least one of the time-domain information and the spatial-domain information of the first to-be-filtered unit to assist the neural network filter in filtering the first to-be-filtered unit. That is, a selection range of reference pictures is enriched to improve filtering performance of the neural network filter, so that filtering effect of the to-be-filtered picture can be improved.

For example, the decoder determines a reference unit matching the first to-be-filtered unit from the at least one reference picture included in the reference picture set, then uses the first to-be-filtered unit and the reference unit that matches the first to-be-filtered unit and that is in the at least one reference picture as inputs of the neural network filter, and outputs the filtered unit of the first to-be-filtered unit.

In this embodiment, if determining to filter the first to-be-filtered unit in the first to-be-filtered information by using the neural network filter, the decoder needs to first determine the at least one reference picture in the reference picture set, and then filter the first to-be-filtered unit by using the neural network filter based on the at least one reference picture, to obtain the filtered unit of the first to-be-filtered unit. The reference picture set includes at least one of the following: the reference picture in the reference picture list of the first to-be-filtered unit, and the to-be-filtered picture to which the first to-be-filtered unit belongs. In addition, the reference picture in the reference picture list of the first to-be-filtered unit can provide time-domain information for the first to-be-filtered unit, and the to-be-filtered picture to which the first to-be-filtered unit belongs may provide spatial-domain information for the first to-be-filtered unit. Therefore, filtering the first to-be-filtered unit by using the neural network filter based on the at least one reference picture is equivalent to using at least one of the time-domain information and the spatial-domain information to assist the neural network filter in filtering the first to-be-filtered unit. That is, a selection range of reference pictures is enriched to improve filtering performance of the neural network filter, so that filtering effect of the to-be-filtered picture can be improved.

In some embodiments, when the at least one reference picture included in the reference picture set forms a first reference picture combination, the first reference picture combination is a reference picture combination with a smallest filtering cost among a plurality of reference picture combinations, and the plurality of reference picture combinations include a reference picture combination obtained by combining reference pictures in the reference picture set.

For example, the plurality of reference picture combinations include a reference picture combination obtained by combining all reference pictures in the reference picture set. For example, the plurality of reference picture combinations may include all reference picture combinations obtained by combining all the reference pictures in the reference picture set. For another example, the plurality of reference picture combinations may include some of all reference picture combinations obtained by combining all the reference pictures in the reference picture set.

For example, the plurality of reference picture combinations include a reference picture combination obtained by combining some reference pictures that are ranked top in the reference picture set. For example, the plurality of reference picture combinations include all reference picture combinations obtained by combining some reference pictures that are ranked top in the reference picture set. For another example, the plurality of reference picture combinations include some of all reference picture combinations obtained by combining some reference pictures that are ranked top in the reference picture set.

Certainly, regardless of a combination form of the plurality of reference picture combinations, understanding of the coder side and the decoder side on the plurality of reference picture combinations needs to keep consistent. For example, the plurality of reference picture combinations may be combinations agreed upon in a protocol, or the plurality of reference picture combinations may be information notified by the coder side (for example, by using one or more flags) to the decoder side.

In this embodiment, a reference picture included in the reference picture combination with the smallest filtering cost among the plurality of reference picture combinations is used as the at least one reference picture. This is equivalent to selecting an optimal reference picture combination from the reference picture set as an input of the neural network filter, so that the neural network filter can be better generalized, to improve filtering performance of the neural network filter, and further improve filtering effect of the to-be-filtered picture.

In some embodiments, the filtering cost is determined based on at least one of the following indicators: a PSNR, an MS-SSIM, and an RDO cost.

In this embodiment, determining the filtering cost based on the PSNR or the MS-SSIM is equivalent to considering differences between content characteristics and quality levels of different reference pictures, and determining the filtering cost based on the RDO is equivalent to adaptively selecting an optimal reference picture combination from the reference picture set as an input of the neural network filter. In this way, the neural network filter can be better generalized, to improve filtering performance of the neural network filter, and further improve filtering effect of the to-be-filtered picture.

For example, the filtering cost is the RDO cost.

FIG. 11 shows an example of at least one reference picture according to an embodiment of this application.

As shown in FIG. 11, it is assumed that the first to-be-filtered unit is a to-be-filtered picture, a frame type of the to-be-filtered picture is a B frame, and the reference picture set includes a forward reference picture list and a backward reference picture list of the to-be-filtered picture. If the at least one reference picture is two reference pictures, the two reference pictures form a first reference picture combination that is a reference picture combination with a smallest RDO cost among the plurality of reference picture combinations. The plurality of reference picture combinations include a reference picture combination 1 formed by a forward reference picture 1 in the forward reference picture list and a backward reference picture 1 in the backward reference picture list, a reference picture combination 2 formed by a forward reference picture 2 in the forward reference picture list and a backward reference picture 2 in the backward reference picture list, and a reference picture combination 3 formed by the forward reference picture 1 in the forward reference picture list and the backward reference picture 2 in the backward reference picture list. That is, the at least one reference picture may include a reference picture included in a reference picture combination with a smallest RDO cost among the reference picture combination 1, the reference picture combination 2, and the reference picture combination 3. Specifically, the coder separately uses the reference picture combination 1, the reference picture combination 2, and the reference picture combination 3 as reference pictures of the to-be-filtered picture to obtain three filtered pictures (to be specific, a filtered picture 1, a filtered picture 2, and a filtered picture 3); then separately calculates an RDO cost of the filtered picture 1, an RDO cost of the filtered picture 2, and an RDO cost of the filtered picture 3; determines a reference picture combination used by a filtered picture with a smallest RDO cost among the three filtered pictures as an optimal reference picture combination; and determines a reference picture in the optimal reference picture combination as the at least one reference picture.

FIG. 12 shows another example of at least one reference picture according to an embodiment of this application.

As shown in FIG. 12, it is assumed that the first to-be-filtered unit is a to-be-filtered picture, a frame type of the to-be-filtered picture is a P frame, and the reference picture set includes a unidirectional reference picture list of the to-be-filtered picture. If the at least one reference picture is one reference picture, the reference picture is a reference picture with a smallest RDO cost among three reference pictures (to be specific, a unidirectional reference picture 1, a unidirectional reference picture 2, and a unidirectional reference picture 3) that are ranked top in the unidirectional reference picture list. Specifically, the coder separately uses the unidirectional reference picture 1, the unidirectional reference picture 2, and the unidirectional reference picture 3 as reference pictures of the to-be-filtered picture to obtain three filtered pictures (to be specific, a filtered picture 1, a filtered picture 2, and a filtered picture 3); then separately calculates an RDO cost of the filtered picture 1, an RDO cost of the filtered picture 2, and an RDO cost of the filtered picture 3; determines a reference picture used by a filtered picture with a smallest RDO cost among the three filtered pictures as an optimal reference picture; and determines the optimal reference picture as the at least one reference picture.

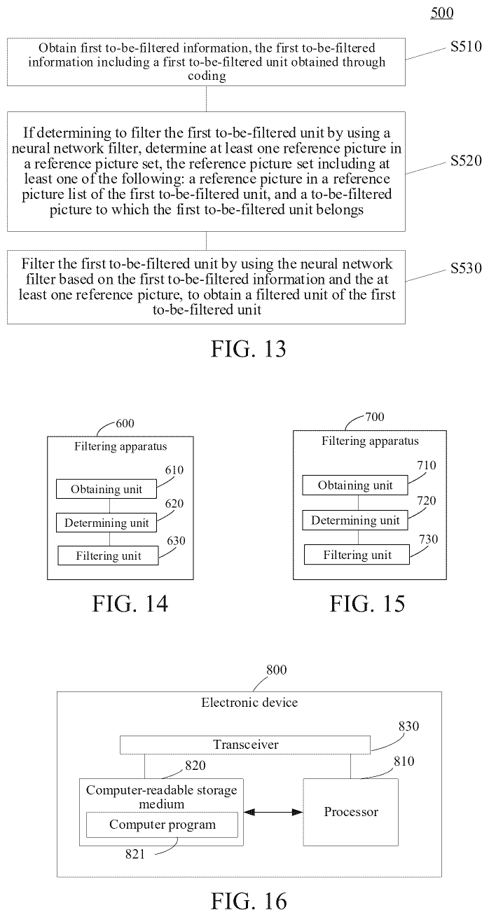

Certainly, in another alternative embodiment, the RDO cost in FIG. 12 and FIG. 13 may alternatively be replaced with a cost of another type, for example, a cost determined based on at least one of the PSNR and the MS-SSIM. This is not limited in this application.

For example, the filtering cost is a cost determined based on the PSNR and the MS-SSIM.

In this embodiment, the filtering cost is determined based on the PSNR and the MS-SSIM. To be specific, filtering costs of reference picture combinations may be determined based on the PSNR and the MS-SSIM, and then an optimal reference picture combination is determined based on the filtering costs of the reference picture combinations. In this way, determining an optimal reference picture combination through a complex RDO selection process can be skipped, to improve filtering efficiency.

For example, the filtering cost may be determined by using the following formula:

Scoreᵢ=PSNRᵢ+λ*MS−SSIMᵢ.
i represents an i^{th} reference picture in the reference picture set. PSNRᵢ represents a quality level of the i^{th} reference picture in the reference picture set. MS-SSIM represents a content difference between the i^{th} reference picture in the reference picture set and the to-be-filtered picture to which the first to-be-filtered unit belongs. λ is a weight factor for balancing PSNRᵢ and MS−SSIMᵢ.

Certainly, in another alternative embodiment, the PSNR or the MS-SSIM may alternatively be replaced with another evaluation indicator, for example, including but not limited to: a sum of absolute differences (SAD), a sum of absolute transformed differences (SATD), a sum of squares for error (SSE), and a mean square error (MSE). Alternatively, the filtering cost may be determined only by using the PSNR, the MS-SSIM, or another indicator. This is not limited in this application.

In some embodiments, S420 may include:
The decoder decodes a code stream to obtain at least one first flag, the at least one first flag being configured for indicating the at least one reference picture in the reference picture set.

For example, when determining, by default, to filter the first to-be-filtered unit by using the at least one reference picture, the decoder may decode the code stream to obtain the at least one first flag, and then determine a reference picture indicated by the at least one first flag as the at least one reference picture.

For example, a value of the at least one first flag may be an index or a subscript of the at least one reference picture in the reference picture set.

For example, the first flag is configured for indicating one or more reference pictures in the reference picture set. The first flag being configured for indicating one reference picture in the reference picture set indicates that the at least one first flag and the at least one reference picture are in a one-to-one correspondence. The first flag being configured for indicating a plurality of reference pictures in the reference picture set indicates that the at least one first flag and the at least one reference picture are in a one-to-many relationship.

From the perspective of coding and decoding, the coder may sequentially obtain reference picture combinations from the reference picture set as additional input information, and transmit the additional input information to the neural network filter to generate corresponding filtering results. Then, the coder determines filtering costs (for example, rate distortion costs) of the reference picture combinations, and selects a reference picture combination with a smallest filtering cost based on the filtering costs of the reference picture combinations, where the reference picture combination may be used as an optimal reference picture combination, namely, the at least one reference picture. Finally, the coder may indicate the at least one reference picture in the reference picture set by using the at least one first flag, and write the at least one first flag into the code stream, so that the decoder can decode the at least one first flag to obtain the at least one reference picture.

For example, it is assumed that the first to-be-filtered unit is a to-be-filtered picture, a frame type of the to-be-filtered picture is a B frame, the reference picture set includes a forward reference picture list and a backward reference picture list of the to-be-filtered picture, and a reference picture inputted to the neural network filter includes one reference picture. In this case, the at least one first flag is one first flag, and possible values of the first flag are shown in the following table:

TABLE 1
The reference picture inputted to the neural network
filter includes only one reference picture.

| | | |
|---|---|---|
| First flag | 00 | Forward reference picture 1 |
| | 01 | Forward reference picture 2 |
| | 10 | Backward reference picture 1 |
| | 11 | Backward reference picture 2 |
| | . . . | . . . |

As shown in Table 1, assuming that a value of the first flag is 00, the forward reference picture 1 may be determined as the at least one reference picture, to be specific, the reference picture inputted to the neural network filter includes only the forward reference picture 1. Similarly, assuming that a value of the first flag is 11, the backward reference picture 2 may be determined as the at least one reference picture, to be specific, the reference picture inputted to the neural network filter includes only the backward reference picture 2. Certainly, the values of the first flag and the correspondences between the values and the reference pictures in Table 1 are merely examples, and are not to be construed as a limitation to this application.

For example, it is assumed that the first to-be-filtered unit is a to-be-filtered picture, a frame type of the to-be-filtered picture is a B frame, the reference picture set includes a forward reference picture list and a backward reference picture list of the to-be-filtered picture, and a reference picture inputted to the neural network filter includes two reference pictures. In this case, the at least one first flag is two first flags, and possible values of the two first flags are shown in the following table:

TABLE 2
The reference picture inputted to the neural network
filter includes two reference pictures.

| | | |
|---|---|---|
| 1^{st} first flag (indicating | 00 | Forward reference picture 1 |
| an index of the first | 01 | Forward reference picture 2 |
| selected reference picture) | 10 | Backward reference picture 1 |
| | 11 | Backward reference picture 2 |
| | . . . | . . . |
| 2^{nd} first flag (indicating | 00 | Forward reference picture 1 |
| an index of the selected | 01 | Forward reference picture 2 |
| second reference picture) | 10 | Backward reference picture 1 |
| | 11 | Backward reference picture 2 |
| | . . . | . . . |

As shown in Table 2, assuming that a value of the 1^{st} first flag is 00 and a value of the 2^{nd} first flag is 01, the forward reference picture 1 and the forward reference picture 2 may be determined as the at least one reference picture, to be specific, the reference picture inputted to the neural network filter includes the forward reference picture 1 and the forward reference picture 2. Similarly, assuming that a value of the 1^{st} first flag is 01 and a value of the 2^{nd} first flag is 10, the forward reference picture 2 and the backward reference picture 1 may be determined as the at least one reference picture, to be specific, the reference picture inputted to the neural network filter includes the forward reference picture 2 and the backward reference picture 1. Certainly, the values of the first flag and the correspondences between the values and the reference pictures in Table 2 are merely examples, and are not to be construed as a limitation to this application.

For example, it is assumed that the first to-be-filtered unit is a to-be-filtered picture, a frame type of the to-be-filtered picture is a P frame, the reference picture set includes a forward reference picture list of the to-be-filtered picture, and a reference picture inputted to the neural network filter includes one reference picture. In this case, the at least one first flag is one first flag, and possible values of the first flag are shown in the following table:

TABLE 3
The reference picture inputted to the neural network
filter includes only one reference picture.

| | | |
|---|---|---|
| First flag | 00 | Forward reference picture 1 |
| | 01 | Forward reference picture 2 |
| | 100 | Forward reference picture 3 |
| | 101 | Forward reference picture 4 |
| | . . . | . . . |

As shown in Table 3, assuming that a value of the first flag is 00, the forward reference picture 1 may be determined as the at least one reference picture, to be specific, the reference picture inputted to the neural network filter includes only the forward reference picture 1. Similarly, assuming that a value of the first flag is 01, the backward reference picture 2 may be determined as the at least one reference picture, to be specific, the reference picture inputted to the neural network filter includes only the backward reference picture 2. Certainly, the values of the first flag and the correspondences between the values and the reference pictures in Table 3 are merely examples, and are not to be construed as a limitation to this application.

For example, it is assumed that the first to-be-filtered unit is a to-be-filtered picture, a frame type of the to-be-filtered picture is a P frame, the reference picture set includes a forward reference picture list of the to-be-filtered picture, and a reference picture inputted to the neural network filter includes two reference pictures. In this case, the at least one first flag is two first flags, and possible values of the two first flags are shown in the following table:

TABLE 4
The reference picture inputted to the neural network
filter includes two reference pictures.

| | | |
|---|---|---|
| 1^{st} first flag (indicating | 00 | Forward reference picture 1 |
| an index of the first selected | 01 | Forward reference picture 2 |
| reference picture) | 100 | Forward reference picture 3 |
| | 101 | Forward reference picture 4 |
| | . . . | . . . |
| 2^{nd} first flag (indicating | 00 | Forward reference picture 1 |
| an index of the selected | 01 | Forward reference picture 2 |
| second reference picture) | 100 | Forward reference picture 3 |
| | 101 | Forward reference picture 4 |
| | . . . | . . . |

As shown in Table 4, assuming that a value of the 1^{st} first flag is 00 and a value of the 2^{nd} first flag is 01, the forward reference picture 1 and the forward reference picture 2 may be determined as the at least one reference picture, to be specific, the reference picture inputted to the neural network filter includes the forward reference picture 1 and the forward reference picture 2. Similarly, assuming that a value of the 1^{st} first flag is 01 and a value of the 2^{nd} first flag is 100, the forward reference picture 2 and the forward reference picture 3 may be determined as the at least one reference picture, to be specific, the reference picture inputted to the neural network filter includes the forward reference picture 2 and the forward reference picture 3. Certainly, the values of the first flag and the correspondences between the values and the reference pictures in Table 4 are merely examples, and are not to be construed as a limitation to this application.

In some embodiments, when the first to-be-filtered unit is a to-be-filtered picture, an i^{th} first flag of the at least one first flag is configured for indicating, in the reference picture set, an i^{th} reference picture of the to-be-filtered picture.

For example, when the first to-be-filtered unit is a to-be-filtered picture, that an i^{th} first flag of the at least one first flag is configured for indicating, in the reference picture set, an i^{th} reference picture of the to-be-filtered picture is equivalent to that the at least one first flag is a frame-level flag (which may also be referred to as a picture-level flag). This can reduce complexity of the at least one first flag, to improve decoding efficiency.

In some embodiments, when the first to-be-filtered unit is a to-be-filtered picture block, an i^{th} first flag of the at least one first flag is configured for indicating, in the reference picture set, a reference picture to which an i^{th} reference picture block of the to-be-filtered picture block belongs.

For example, when the first to-be-filtered unit is a to-be-filtered picture block, that an i^{th} first flag of the at least one first flag is configured for indicating, in the reference picture set, a reference picture to which an i^{th} reference picture block of the to-be-filtered picture block belongs is equivalent to that the at least one first flag is a block-level flag and the block-level flag indicates picture-level information. This avoids directly indicating a reference picture block of the to-be-filtered picture block, and can reduce complexity of the at least one first flag, to improve decoding efficiency.

Certainly, regardless of whether the i^{th} first flag of the at least one first flag is configured for indicating, in the reference picture set, the i^{th} reference picture of the to-be-filtered picture or the i^{th} first flag of the at least one first flag is configured for indicating, in the reference picture set, the reference picture to which the i^{th} reference picture block of the to-be-filtered picture block belongs, the at least one first flag and the at least one reference picture are in a one-to-one correspondence. However, this application is not limited thereto. For example, in another alternative embodiment, the at least one first flag and the at least one reference picture are in a one-to-many relationship. In an example, the at least one first flag may alternatively be one first flag, and the first flag is configured for indicating a first reference picture combination. In this case, the decoder may determine a reference picture in the first reference picture combination indicated by the first flag as the at least one reference picture. In another example, a part of the at least one first flag may be configured for indicating a plurality of reference pictures in the reference picture set, and another part of the at least one first flag may be configured for indicating one reference picture in the reference picture set. A specific implementation may be adjusted according to an actual requirement. This is not limited in this application.

In some embodiments, that the decoder obtains at least one first flag may be implemented as follows:
The decoder decodes the code stream to obtain a second flag; and if the second flag indicates to filter the first to-be-filtered unit by using a reference picture, decodes the code stream to obtain the at least one first flag.

For example, the decoder first parses the second flag, to indicate whether to select a reference picture as an input of the neural network filter. If determining to select a reference picture as an input, the decoder continues to parse the subsequent at least one first flag, to indicate specific one or more pictures that are to be specifically selected as reference pictures.

From the perspective of coding and decoding, the coder may sequentially obtain reference picture combinations from the reference picture set as additional input information, and transmit the additional input information to the neural network filter to generate corresponding filtering results. Then, the coder determines filtering costs of the reference picture combinations, selects a reference picture combination with a smallest filtering cost based on the filtering costs of the reference picture combinations, determines whether to filter the first to-be-filtered unit by using a reference picture, and writes, to the code stream, the second flag configured for indicating whether to filter the first to-be-filtered unit by using a reference picture. If determining to filter the first to-be-filtered unit by using a reference picture, the coder may select the reference picture combination with the smallest filtering cost as an optimal reference picture combination, namely, the at least one reference picture, based on the filtering costs of the reference picture combinations. Further, the coder may write the at least one first flag to the code stream, to indicate a to-be-used reference picture, namely, the at least one reference picture, in the reference picture set. The decoder may decode the second flag to determine whether to filter the first to-be-filtered unit by using a reference picture, and when determining to filter the first to-be-filtered unit by using a reference picture, decode the at least one first flag to obtain the at least one reference picture.

For example, it is assumed that the first to-be-filtered unit is a to-be-filtered picture, a frame type of the to-be-filtered picture is a B frame, the reference picture set includes a forward reference picture list and a backward reference picture list of the to-be-filtered picture, and a reference picture inputted to the neural network filter includes one reference picture. In this case, the at least one first flag is one first flag, and possible values of the second flag and the at least one first flag (when the at least one first flag exists, in other words, when the to-be-filtered picture needs to be filtered by using a reference picture) are shown in the following table:

TABLE 5
The reference picture inputted to the neural network
filter includes only one reference picture.

| | | |
|---|---|---|
| Second flag | 0 | No reference picture is selected |
| | | as an additional input. |
| | 1 | A reference picture is selected |
| | | as an additional input. |
| First flag | 00 | Forward reference picture 1 |
| | 01 | Forward reference picture 2 |
| | 10 | Backward reference picture 1 |
| | 11 | Backward reference picture 2 |
| | . . . | . . . |

As shown in Table 5, the decoder side first decodes the second flag, and if a value of the second flag is 1, continues to decode the subsequent first flag, to indicate a specific picture that is to be specifically selected as a reference picture. Assuming that a value of the first flag is 00, the forward reference picture 1 may be determined as the at least one reference picture, to be specific, the reference picture inputted to the neural network filter includes only the forward reference picture 1. Similarly, assuming that a value of the first flag is 11, the backward reference picture 2 may be determined as the at least one reference picture, to be specific, the reference picture inputted to the neural network filter includes only the backward reference picture 2. Certainly, the values of the first flag and the correspondences between the values and the reference pictures in Table 5 are merely examples, and are not to be construed as a limitation to this application.

For example, it is assumed that the first to-be-filtered unit is a to-be-filtered picture, a frame type of the to-be-filtered picture is a B frame, the reference picture set includes a forward reference picture list and a backward reference picture list of the to-be-filtered picture, and a reference picture inputted to the neural network filter includes two reference pictures. In this case, the at least one first flag is two first flags, and possible values of the second flag and the at least one first flag (when the at least one first flag exists, in other words, when the to-be-filtered picture needs to be filtered by using a reference picture) are shown in the following table:

TABLE 6
The reference picture inputted to the neural network
filter includes two reference pictures.

| | | |
|---|---|---|
| Second flag | 0 | No reference picture is selected |
| | | as an additional input. |
| | 1 | A reference picture is selected |
| | | as an additional input. |
| 1^{st} first flag | 00 | Forward reference picture 1 |
| (indicating an | 01 | Forward reference picture 2 |
| index of the first | 10 | Backward reference picture 1 |
| selected reference | 11 | Backward reference picture 2 |
| picture) | . . . | . . . |
| 2^{nd} first flag | 00 | Forward reference picture 1 |
| (indicating an | 01 | Forward reference picture 2 |
| index of the | 10 | Backward reference picture 1 |
| selected second | 11 | Backward reference picture 2 |
| reference picture) | . . . | . . . |

As shown in Table 6, the decoder side first decodes the second flag, and if a value of the second flag is 1, continues to decode the subsequent two first flags, to indicate two specific pictures that are to be specifically selected as reference pictures. Assuming that a value of the 1^{st} first flag is 00 and a value of the 2^{nd} first flag is 01, the forward reference picture 1 and the forward reference picture 2 may be determined as the at least one reference picture, to be specific, the reference picture inputted to the neural network filter includes the forward reference picture 1 and the forward reference picture 2. Similarly, assuming that a value of the 1^{st} first flag is 01 and a value of the 2^{nd} first flag is 10, the forward reference picture 2 and the backward reference picture 1 may be determined as the at least one reference picture, to be specific, the reference picture inputted to the neural network filter includes the forward reference picture 2 and the backward reference picture 1. Certainly, the values of the first flag and the correspondences between the values and the reference pictures in Table 6 are merely examples, and are not to be construed as a limitation to this application.

For example, it is assumed that the first to-be-filtered unit is a to-be-filtered picture, a frame type of the to-be-filtered picture is a P frame, the reference picture set includes a forward reference picture list of the to-be-filtered picture, and a reference picture inputted to the neural network filter includes one reference picture. In this case, the at least one first flag is one first flag, and possible values of the second flag and the at least one first flag (when the at least one first flag exists, in other words, when the to-be-filtered picture needs to be filtered by using a reference picture) are shown in the following table:

TABLE 7
The reference picture inputted to the neural network
filter includes only one reference picture.

| | | |
|---|---|---|
| Second flag | 0 | No reference picture is selected |
| | | as an additional input. |
| | 1 | A reference picture is selected |
| | | as an additional input. |
| First flag | 00 | Forward reference picture 1 |
| | 01 | Forward reference picture 2 |
| | 100 | Forward reference picture 3 |
| | 101 | Forward reference picture 4 |
| | . . . | . . . |

As shown in Table 7, the decoding apparatus first decodes the second flag, and if a value of the second flag is 1, continues to decode the subsequent first flag, to indicate a specific picture that is to be specifically selected as a reference picture. Assuming that a value of the first flag is 00, the forward reference picture 1 may be determined as the at least one reference picture, to be specific, the reference picture inputted to the neural network filter includes only the forward reference picture 1. Similarly, assuming that a value of the first flag is 01, the backward reference picture 2 may be determined as the at least one reference picture, to be specific, the reference picture inputted to the neural network filter includes only the backward reference picture 2. Certainly, the values of the first flag and the correspondences between the values and the reference pictures in Table 7 are merely examples, and are not to be construed as a limitation to this application.

For example, it is assumed that the first to-be-filtered unit is a to-be-filtered picture, a frame type of the to-be-filtered picture is a P frame, the reference picture set includes a forward reference picture list of the to-be-filtered picture, and a reference picture inputted to the neural network filter includes two reference pictures. In this case, the at least one first flag is two first flags, and possible values of the second flag and the at least one first flag (when the at least one first flag exists, in other words, when the to-be-filtered picture needs to be filtered by using a reference picture) are shown in the following table:

TABLE 8
The reference picture inputted to the neural network
filter includes two reference pictures.

| | | |
|---|---|---|
| Second flag | 0 | No reference picture is selected |
| | | as an additional input. |
| | 1 | A reference picture is selected |
| | | as an additional input. |
| 1^{st} first flag | 00 | Forward reference picture 1 |
| (indicating an | 01 | Forward reference picture 2 |
| index of the first | 100 | Forward reference picture 3 |
| selected reference | 101 | Forward reference picture 4 |
| picture) | . . . | . . . |
| 2^{nd} first flag | 00 | Forward reference picture 1 |
| (indicating an | 01 | Forward reference picture 2 |
| index of the | 100 | Forward reference picture 3 |
| selected second | 101 | Forward reference picture 4 |
| reference picture) | . . . | . . . |

As shown in Table 8, the decoder side first decodes the second flag, and if a value of the second flag is 1, continues to decode the subsequent two first flags, to indicate two specific pictures that are to be specifically selected as reference pictures. Assuming that a value of the 1^{st} first flag is 00 and a value of the 2^{nd} first flag is 01, the forward reference picture 1 and the forward reference picture 2 may be determined as the at least one reference picture, to be specific, the reference picture inputted to the neural network filter includes the forward reference picture 1 and the forward reference picture 2. Similarly, assuming that a value of the 1^{st} first flag is 01 and a value of the 2^{nd} first flag is 100, the forward reference picture 2 and the forward reference picture 3 may be determined as the at least one reference picture, to be specific, the reference picture inputted to the neural network filter includes the forward reference picture 2 and the forward reference picture 3. Certainly, the values of the first flag and the correspondences between the values and the reference pictures in Table 8 are merely examples, and are not to be construed as a limitation to this application.

Certainly, in another alternative embodiment, the decoder may determine, by default, that a reference picture needs to be selected as an input of the neural network filter. To be specific, the decoder may directly parse the at least one first flag, to indicate specific one or more pictures that are to be specifically selected as reference pictures.

From the perspective of coding and decoding, the coder may determine, by default, to filter the first to-be-filtered unit by using a reference picture. To be specific, the coder sequentially obtains reference picture combinations from the reference picture set as additional input information, and transmits the additional input information to the neural network filter to generate corresponding filtering results. Then, the coder determines filtering costs of the reference picture combinations, and selects a reference picture combination with a smallest filtering cost as an optimal reference picture combination, namely, the at least one reference picture, based on the filtering costs of the reference picture combinations. Further, the coder may write the at least one first flag to the code stream, to indicate a to-be-used reference picture, namely, the at least one reference picture, in the reference picture set. The decoder may determine, by default, to filter the first to-be-filtered unit by using a reference picture, to be specific, may directly decode the at least one first flag to obtain the at least one reference picture.

Certainly, in another alternative embodiment, the second flag and the at least one first flag may be combined into a third flag. For example, the third flag is obtained by decoding the code stream, and the third flag indicates whether to filter the first to-be-filtered unit by using a reference picture. Further, when indicating to filter the first to-be-filtered unit by using a reference picture, the third flag is further configured for indicating the at least one reference picture, to be specific, configured for indicating the first reference picture combination among the plurality of reference picture combinations.

In some embodiments, when the quantity of the at least one reference picture is an integer greater than 1, reference pictures among the at least one reference picture are different from each other.

For example, when the quantity of the at least one reference picture is N and N>1, the reference pictures among the at least one reference picture are different from each other. In other words, when the quantity of the at least one reference picture is N and N>1, a k^{th} reference picture of the at least one reference picture is different from any one of the first k−1 reference pictures. For example, the last one of the at least one reference picture is different from any one of the first N−1 reference pictures.

In this embodiment, when the quantity of the at least one reference picture is an integer greater than 1, the reference pictures among the at least one reference picture are different from each other, so that the at least one reference picture can provide reference information for the neural network filter as abundant as possible to filter the first to-be-filtered unit. This can improve filtering performance of the neural network filter and filtering effect of the first to-be-filtered unit.

Certainly, in another alternative embodiment, when the quantity of the at least one reference picture is an integer greater than 1, reference pictures among the at least one reference picture may be partially the same or completely the same. This is not specifically limited in this application.

In some embodiments, S430 may include:
when the first to-be-filtered unit is a to-be-filtered picture, filtering the first to-be-filtered unit by using the neural network filter and by using the first to-be-filtered information and the at least one reference picture as inputs, to obtain the filtered unit of the first to-be-filtered unit; or when the first to-be-filtered unit is a to-be-filtered picture block, filtering the first to-be-filtered unit by using the neural network filter and by using, as inputs, the first to-be-filtered information and at least one reference picture block that is in the at least one reference picture and that matches the to-be-filtered picture block, to obtain the filtered unit of the first to-be-filtered unit.

For example, if the first to-be-filtered unit is a to-be-filtered picture, when filtering the first to-be-filtered picture by using the at least one reference picture, the decoder side may first select N reference pictures, and then use the N reference pictures and the first to-be-filtered information as inputs to the neural network filter. To be specific, information inputted to an NNLF includes the N reference pictures and the first to-be-filtered information.

For example, if the first to-be-filtered unit is a to-be-filtered picture block, when filtering the first to-be-filtered picture by using the at least one reference picture, the decoder side may first select N reference pictures; then determine, from the at least one reference picture, N reference picture blocks matching the to-be-filtered picture block; and then use the N reference picture blocks and the first to-be-filtered information as inputs to the neural network filter. To be specific, information inputted to an NNLF includes the N reference picture blocks and the first to-be-filtered information.

In some embodiments, a reference picture block that is in any one of the at least one reference picture and that matches the to-be-filtered picture block includes at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

For example, the reference picture block that is in the any reference picture and that matches the to-be-filtered picture block may include the picture block that is in the any reference picture and whose position is the same as that of the first to-be-filtered unit. The picture block that is in the any reference picture and whose position is the same as that of the first to-be-filtered unit may be a picture block that is in the any reference picture and whose position is the same as that of the first to-be-filtered unit in the to-be-filtered picture to which the first to-be-filtered unit belongs. In other words, the picture block that is in the any reference picture and whose position is the same as that of the first to-be-filtered unit may be a co-located reference block in the any reference picture. The co-located reference block may be a picture block that is in the any reference picture and whose position is the same as that of the first to-be-filtered unit in the to-be-filtered picture to which the first to-be-filtered unit belongs.

For example, the reference picture block that is in the any reference picture and that matches the to-be-filtered picture block may include the picture block that is in the any reference picture and whose position is adjacent to the first to-be-filtered unit. The picture block that is in the any reference picture and whose position is adjacent to the first to-be-filtered unit may be a picture block that is in the any reference picture and whose position is adjacent to a co-located reference block of the first to-be-filtered unit. The co-located reference block may be a picture block that is in the any reference picture and whose position is the same as that of the first to-be-filtered unit in the to-be-filtered picture to which the first to-be-filtered unit belongs. The picture block that is in the any reference picture and whose position is adjacent to the first to-be-filtered unit includes but is not limited to: a picture block that is in the any reference picture and that has a common point with the first to-be-filtered unit, a picture block that is in the any reference picture and that is colinear with the first to-be-filtered unit, and a picture block that is in the any reference picture and that is coplanar with the first to-be-filtered unit.

For example, the reference picture block that is in the any reference picture and that matches the to-be-filtered picture block may include the picture block that is in the any reference picture and whose distance from the first to-be-filtered unit is the preset distance. The picture block that is in the any reference picture and whose distance from the first to-be-filtered unit is the preset distance may be a picture block that is in the any reference picture and whose distance from a co-located reference block of the first to-be-filtered unit is the preset distance. The co-located reference block may be a picture block that is in the any reference picture and whose position is the same as that of the first to-be-filtered unit in the to-be-filtered picture to which the first to-be-filtered unit belongs. The preset distance may be a distance agreed upon in a protocol, or the preset distance may be information stored in a storage medium of the decoder. The preset distance may be any value greater than 0, for example, an integer. The distance from the first to-be-filtered unit in the any reference picture may be a Euclidean distance, a Morton distance, a Hilbert distance, or the like.

In some embodiments, the first to-be-filtered information further includes at least one of the following:
a prediction unit corresponding to the first to-be-filtered unit, a QP of the to-be-filtered picture to which the first to-be-filtered unit belongs, and a frame type of the to-be-filtered picture to which the first to-be-filtered unit belongs.

For example, the prediction unit corresponding to the first to-be-filtered unit may be a predicted picture configured for determining the first to-be-filtered unit. For example, when the first to-be-filtered unit is a to-be-filtered reconstructed picture and the to-be-filtered reconstructed picture is a reconstructed picture determined based on a predicted picture of an original picture and a residual picture of the original picture, the prediction unit corresponding to the first to-be-filtered unit may be the predicted picture of the original picture.

For example, the QP of the to-be-filtered picture to which the first to-be-filtered unit belongs may include at least one of the following: a base QP and a slice QP. Certainly, the QP of the to-be-filtered picture to which the first to-be-filtered unit belongs may alternatively be a QP at another granularity, for example, a block QP. This is not limited in this application.

For example, the frame type of the to-be-filtered picture to which the first to-be-filtered unit belongs includes at least one of the following: a P frame, a B frame, and an I frame. The frame type of the to-be-filtered picture to which the first to-be-filtered unit belongs may also be referred to as a slice type of the to-be-filtered picture to which the first to-be-filtered unit belongs.

In some embodiments, S430 may include:
The decoder side filters at least one of the following of the first to-be-filtered unit by using the neural network filter based on the first to-be-filtered information and the at least one reference picture, to obtain the filtered unit of the first to-be-filtered unit: a luminance component of the first to-be-filtered unit, and a chrominance component of the first to-be-filtered unit.

In this embodiment, at least one of the luminance component (Y) and the chrominance component (UV) of the first to-be-filtered unit may be filtered by using the at least one reference picture. This is equivalent to using at least one of the time-domain information and the spatial-domain information to assist the neural network filter in filtering at least one of the luminance component (Y) and the chrominance component (UV) of the first to-be-filtered unit. That is, a selection range of reference pictures is enriched to improve filtering performance of the neural network filter, so that filtering effect of the to-be-filtered picture at each component can be improved.

A filtering method 500 according to an embodiment of this application is described below with reference to FIG. 13 from the perspective of coding.

The filtering method 500 may be performed by a coder. For example, the filtering method 500 may be performed by a filtering apparatus in the coding device 110 or the coder 112 shown in FIG. 1. For another example, the filtering method 500 may be performed by a filtering apparatus in the video coder 200 shown in FIG. 2. Descriptions are provided below by using an example in which the method is performed by a coder.

As shown in FIG. 13, the filtering method 500 may include the following operations:
S510: The coder obtains first to-be-filtered information, the first to-be-filtered information including a first to-be-filtered unit obtained through coding.

The first to-be-filtered unit includes a to-be-filtered picture, a to-be-filtered picture block, and the like.
S520: If determining to filter the first to-be-filtered unit by using a neural network filter, the coder determines at least one reference picture in a reference picture set, the reference picture set including at least one of the following: a reference picture in a reference picture list of the first to-be-filtered unit, and a to-be-filtered picture to which the first to-be-filtered unit belongs.
S530: The coder filters the first to-be-filtered unit by using the neural network filter based on the first to-be-filtered information and the at least one reference picture, to obtain a filtered unit of the first to-be-filtered unit.

In some embodiments, S520 may include:
The coder obtains a plurality of reference picture combinations, the plurality of reference picture combinations including a reference picture combination obtained by combining reference pictures in the reference picture set.

The coder determines a filtering cost of using each of the plurality of reference picture combinations.

The coder determines, based on the filtering cost of each reference picture combination, a reference picture included in a reference picture combination with a smallest filtering cost as the at least one reference picture.

In some embodiments, the filtering cost is determined based on at least one of the following indicators: a PSNR, an MS-SSIM, and an RDO cost.

In some embodiments, the method 500 may further include:
coding at least one first flag,
the at least one first flag being configured for indicating the at least one reference picture in the reference picture set.

In some embodiments, when the first to-be-filtered unit is a to-be-filtered picture, an i^{th} first flag of the at least one first flag is configured for indicating, in the reference picture list, an i^{th} reference picture of the to-be-filtered picture.

In some embodiments, when the first to-be-filtered unit is a to-be-filtered picture block, an i^{th} first flag of the at least one first flag is configured for indicating, in the reference picture list, a reference picture to which an i^{th} reference picture block of the to-be-filtered picture block belongs.

In some embodiments, the method 500 may further include:
coding a second flag,
the second flag indicating to filter the first to-be-filtered unit by using a reference picture.

In some embodiments, when the quantity of the at least one reference picture is an integer greater than 1, reference pictures among the at least one reference picture are different from each other.

In some embodiments, S530 may include:
when the first to-be-filtered unit is a to-be-filtered picture, filtering the first to-be-filtered unit by using the neural network filter and by using the first to-be-filtered information and the at least one reference picture as inputs, to obtain the filtered unit of the first to-be-filtered unit; or
when the first to-be-filtered unit is a to-be-filtered picture block, filtering the first to-be-filtered unit by using the neural network filter and by using, as inputs, the first to-be-filtered information and at least one reference picture block that is in the at least one reference picture and that matches the to-be-filtered picture block, to obtain the filtered unit of the first to-be-filtered unit.

In some embodiments, a reference picture block that is in any one of the at least one reference picture and that matches the to-be-filtered picture block includes at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

In some embodiments, the first to-be-filtered information further includes at least one of the following:
a prediction unit corresponding to the first to-be-filtered unit, a QP of the to-be-filtered picture to which the first to-be-filtered unit belongs, and a frame type of the to-be-filtered picture to which the first to-be-filtered unit belongs.

In some embodiments, S530 may include:
filtering at least one of the following of the first to-be-filtered unit by using the neural network filter based on the first to-be-filtered information and the at least one reference picture, to obtain the filtered unit of the first to-be-filtered unit:
a luminance component of the first to-be-filtered unit, and a chrominance component of the first to-be-filtered unit.

The filtering method 400 may be understood as a filtering method used in a decoding method, and the filtering method 500 may be understood as a filtering method used in a coding method. Specific principles thereof are similar, and a difference lies in: The filtering method 400 is configured for filtering a to-be-filtered unit obtained through decoding, and the filtering method 500 is configured for filtering a to-be-filtered unit obtained through coding. Therefore, for a specific solution of the filtering method 500, refer to related content of the filtering method 400. For ease of description, details are not described herein again.

The exemplary implementations of this application are described in detail above with reference to the accompanying drawings. However, this application is not limited to the specific details in the foregoing implementations. A plurality of simple variations may be made to the technical solutions of this application within a scope of the technical concept of this application. These simple variations fall within the protection scope of this application. For example, the specific technical features described in the foregoing specific implementations may be combined in any proper manner in a case without conflict. To avoid unnecessary repetition, various possible combinations are not additionally described in this application. For another example, different implementations of this application may alternatively be combined in any manner without departing from the idea of this application. These combinations shall still be regarded as content disclosed in this application.

In the method embodiments of this application, sequence numbers of the foregoing processes do not indicate execution sequences. The execution sequences of the processes are to be determined based on functions and internal logic of the processes, and not to be construed as any limitation on the implementation processes of the embodiments of this application.

The following describes apparatus embodiments of this application in detail with reference to the accompanying drawings.

FIG. 14 is a schematic block diagram of a filtering apparatus 600 according to this application. The filtering apparatus is applied to a decoding device.

As shown in FIG. 14, the filtering apparatus 600 may include:
an obtaining unit 610, configured to obtain first to-be-filtered information, the first to-be-filtered information including a first to-be-filtered unit obtained through decoding, and the first to-be-filtered unit including a to-be-filtered picture or a to-be-filtered picture block;
a determining unit 620, configured to: if determining to filter the first to-be-filtered unit by using a neural network filter, determine at least one reference picture in a reference picture set, the reference picture set including at least one of the following: a reference picture in a reference picture list of the first to-be-filtered unit, and a to-be-filtered picture to which the first to-be-filtered unit belongs; and
a filtering unit 630, configured to filter the first to-be-filtered unit by using the neural network filter based on the first to-be-filtered information and the at least one reference picture, to obtain a filtered unit of the first to-be-filtered unit.

In some embodiments, when the at least one reference picture forms a first reference picture combination, the first reference picture combination is a reference picture combination with a smallest filtering cost among a plurality of reference picture combinations, and the plurality of reference picture combinations include a reference picture combination obtained by combining reference pictures in the reference picture set.

In some embodiments, the filtering cost is determined based on at least one of the following indicators: a PSNR, an MS-SSIM, and an RDO cost.

In some embodiments, the determining unit 620 is specifically configured to:
decode a code stream to obtain at least one first flag, the at least one first flag being configured for indicating the at least one reference picture in the reference picture set.

In some embodiments, when the first to-be-filtered unit is a to-be-filtered picture, an i^{th} first flag of the at least one first flag is configured for indicating, in the reference picture set, an i^{th} reference picture of the to-be-filtered picture.

In some embodiments, when the first to-be-filtered unit is a to-be-filtered picture block, an i^{th} first flag of the at least one first flag is configured for indicating, in the reference picture set, a reference picture to which an i^{th} reference picture block of the to-be-filtered picture block belongs.

In some embodiments, the determining unit 620 is specifically configured to:
decode the code stream to obtain a second flag; and if the second flag indicates to filter the first to-be-filtered unit by using a reference picture, decode the code stream to obtain the at least one first flag.

In some embodiments, when the quantity of the at least one reference picture is an integer greater than 1, reference pictures among the at least one reference picture are different from each other.

In some embodiments, the filtering unit 630 is specifically configured to:
when the first to-be-filtered unit is a to-be-filtered picture, filter the first to-be-filtered unit by using the neural network filter and by using the first to-be-filtered information and the at least one reference picture as inputs, to obtain the filtered unit of the first to-be-filtered unit; or when the first to-be-filtered unit is a to-be-filtered picture block, filter the first to-be-filtered unit by using the neural network filter and by using, as inputs, the first to-be-filtered information and at least one reference picture block that is in the at least one reference picture and that matches the to-be-filtered picture block, to obtain the filtered unit of the first to-be-filtered unit.

In some embodiments, a reference picture block that is in any one of the at least one reference picture and that matches the to-be-filtered picture block includes at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

In some embodiments, the first to-be-filtered information further includes at least one of the following:
a prediction unit corresponding to the first to-be-filtered unit, a QP of the to-be-filtered picture to which the first to-be-filtered unit belongs, and a frame type of the to-be-filtered picture to which the first to-be-filtered unit belongs.

In some embodiments, the filtering unit 630 is specifically configured to:
filter at least one of the following of the first to-be-filtered unit by using the neural network filter based on the first to-be-filtered information and the at least one reference picture, to obtain the filtered unit of the first to-be-filtered unit: a luminance component of the first to-be-filtered unit, and a chrominance component of the first to-be-filtered unit.

The apparatus embodiments and the method embodiments of the filtering method may correspond to each other. For similar descriptions, refer to the method embodiments. Specifically, the filtering apparatus 600 may correspond to a corresponding entity for performing the filtering method 400 in the embodiments of this application, and the foregoing and other operations and/or functions of the units in the filtering apparatus 600 are respectively intended to implement corresponding processes in the filtering method 400. To avoid repetition, details are not described herein again.

FIG. 15 is a schematic block diagram of a filtering apparatus 700 according to this application. The filtering apparatus is applied to a coding device.

As shown in FIG. 15, the filtering apparatus 700 may include:
an obtaining unit 710, configured to obtain first to-be-filtered information, the first to-be-filtered information including a first to-be-filtered unit obtained through coding, and the first to-be-filtered unit including a to-be-filtered picture or a to-be-filtered picture block;
a determining unit 720, configured to: if determining to filter the first to-be-filtered unit by using a neural network filter, determine at least one reference picture in a reference picture set, the reference picture set including at least one of the following: a reference picture in a reference picture list of the first to-be-filtered unit, and a to-be-filtered picture to which the first to-be-filtered unit belongs; and
a filtering unit 730, configured to filter the first to-be-filtered unit by using the neural network filter based on the first to-be-filtered information and the at least one reference picture, to obtain a filtered unit of the first to-be-filtered unit.

In some embodiments, the determining unit 720 is specifically configured to:
obtain a plurality of reference picture combinations, the plurality of reference picture combinations including a reference picture combination obtained by combining reference pictures in the reference picture set;
determine a filtering cost of using each of the plurality of reference picture combinations; and
determine, based on the filtering cost of each reference picture combination, a reference picture included in a reference picture combination with a smallest filtering cost as the at least one reference picture.

In some embodiments, the filtering cost is determined based on at least one of the following indicators: a PSNR, an MS-SSIM, and an RDO cost.

In some embodiments, the determining unit 720 is further configured to:
code at least one first flag,
the at least one first flag being configured for indicating the at least one reference picture in the reference picture set.

In some embodiments, when the first to-be-filtered unit is a to-be-filtered picture, an i^{th} first flag of the at least one first flag is configured for indicating, in the reference picture list, an i^{th} reference picture of the to-be-filtered picture.

In some embodiments, when the first to-be-filtered unit is a to-be-filtered picture block, an i^{th} first flag of the at least one first flag is configured for indicating, in the reference picture list, a reference picture to which an i^{th} reference picture block of the to-be-filtered picture block belongs.

In some embodiments, the determining unit 720 is specifically configured to:
code a second flag,
the second flag indicating to filter the first to-be-filtered unit by using a reference picture.

In some embodiments, when the quantity of the at least one reference picture is an integer greater than 1, reference pictures among the at least one reference picture are different from each other.

In some embodiments, the filtering unit 730 is specifically configured to:
when the first to-be-filtered unit is a to-be-filtered picture, filter the first to-be-filtered unit by using the neural network filter and by using the first to-be-filtered information and the at least one reference picture as inputs, to obtain the filtered unit of the first to-be-filtered unit; or
when the first to-be-filtered unit is a to-be-filtered picture block, filter the first to-be-filtered unit by using the neural network filter and by using, as inputs, the first to-be-filtered information and at least one reference picture block that is in the at least one reference picture and that matches the to-be-filtered picture block, to obtain the filtered unit of the first to-be-filtered unit.

In some embodiments, a reference picture block that is in any one of the at least one reference picture and that matches the to-be-filtered picture block includes at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

In some embodiments, the first to-be-filtered information further includes at least one of the following:
a prediction unit corresponding to the first to-be-filtered unit, a QP of the to-be-filtered picture to which the first to-be-filtered unit belongs, and a frame type of the to-be-filtered picture to which the first to-be-filtered unit belongs.

In some embodiments, the filtering unit 730 is specifically configured to:
filter at least one of the following of the first to-be-filtered unit by using the neural network filter based on the first to-be-filtered information and the at least one reference picture, to obtain the filtered unit of the first to-be-filtered unit:
a luminance component of the first to-be-filtered unit, and a chrominance component of the first to-be-filtered unit.

The apparatus embodiments of the coder and the method embodiments of the filtering method may correspond to each other. For similar descriptions, refer to the method embodiments. The filtering apparatus 700 may correspond to a corresponding entity for performing the filtering method 500 in the embodiments of this application, and the foregoing and other operations and/or functions of the units in the filtering apparatus 700 are respectively intended to implement corresponding processes in the methods such as the filtering method 500. To avoid repetition, details are not described herein again.

The units in the filtering apparatus 600 or the filtering apparatus 700 in the embodiments of this application are divided based on logical functions. During actual application, a function of one unit may be implemented by a plurality of units, or functions of a plurality of units may be implemented by one unit, or these functions may even be cooperatively implemented by one or more other units. For example, some or all of units in the filtering apparatus 600 or the filtering apparatus 700 are combined into one or more other units. For another example, one or more units in the filtering apparatus 600 or the filtering apparatus 700 may alternatively be split into a plurality of units with smaller functions. In this way, the same operations can be implemented, without affecting achievement of the technical effects of the embodiments of this application. For another example, the filtering apparatus 600 or the filtering apparatus 700 may alternatively include another unit. During actual application, these functions may alternatively be cooperatively implemented by another unit and may be cooperatively implemented by a plurality of units.

According to another embodiment of this application, a computer program (including program code) capable of performing the operations included in a corresponding method may be run on a general-purpose computing device of a general-purpose computer that includes a processing element and a storage element such as a central processing unit (CPU), a random access memory (RAM), and a read-only memory (ROM), to construct the filtering apparatus 600 and the filtering apparatus 700 in the embodiments of this application, and implement the filtering method in the embodiments of this application. The computer program may be stored in, for example, a computer-readable storage medium, and is installed on an electronic device through the computer-readable storage medium. When the computer program is run on the electronic device, a corresponding method in the embodiments of this application is performed.

In other words, the foregoing units may be implemented in a form of hardware, or may be implemented by instructions in a form of software, or may be implemented by a combination of hardware and software.

Specifically, the operations of the method embodiments in the embodiments of this application may be performed by a hardware integrated logic circuit in a processor and/or instructions in a form of software. The operations of the methods disclosed in the embodiments of this application may be directly embodied as being performed by a hardware decoding processor, or may be performed by a combination of hardware and software in a decoding processor. In some embodiments, the software may be located in a mature storage medium in the art, for example, a RAM, a flash memory, a ROM, a programmable ROM (PROM), an electrically erasable programmable memory, or a register. The processor reads information in the storage medium and completes the operations in the foregoing method embodiments in combination with hardware thereof.

FIG. 16 is a schematic structural diagram of an electronic device 800 according to this application.

As shown in FIG. 16, the electronic device 800 includes at least a processor 810 and a computer-readable storage medium 820. The processor 810 and the computer-readable storage medium 820 may be connected through a bus or in another manner. The computer-readable storage medium 820 may be configured to store a computer program 821. The computer program 821 includes computer instructions. The processor 810 is configured to execute the computer instructions stored in the computer-readable storage medium 820. The processor 810 is a computing core and a control core of the electronic device 800, is suitable for implementing one or more computer instructions, and is specifically suitable for loading and executing one or more computer instructions to implement a corresponding method process or a corresponding function.

For example, the processor 810 may also be referred to as a CPU. The processor 810 may include but is not limited to a general-purpose processor, a digital signal processor (DSP), an application-specific integrated circuit (ASIC), a field programmable gate array (FPGA), another programmable logic device, a transistor logic device, a discrete hardware component, and the like.

For example, the computer-readable storage medium 820 may be a high-speed RAM, or may be a non-volatile memory, for example, at least one magnetic disk memory, or in some embodiments, may be at least one computer-readable storage medium located away from the processor 810. Specifically, the computer-readable storage medium 820 includes but is not limited to a volatile memory and/or a non-volatile memory. The non-volatile memory may be a ROM, a PROM, an erasable PROM (EPROM), an electrically EPROM (EEPROM), or a flash memory. The volatile memory may be a RAM, serving as an external cache. By way of example but not limitative description, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM).

For example, the electronic device 800 may be the filtering apparatus in the embodiments of this application, the computer-readable storage medium 820 stores computer instructions, and the processor 810 loads and executes the computer instructions stored in the computer-readable storage medium 820 to implement corresponding operations in the filtering method provided in this application. In other words, the computer instructions in the computer-readable storage medium 820 may be loaded by the processor 810 to perform corresponding operations. To avoid repetition, details are not described herein again.

According to another aspect of this application, this application further provides a coding method or a coder. In the coding method, coding may be performed by using the filtering method provided in this application. The coder may perform coding by using the filtering method provided in this application.

According to another aspect of this application, this application further provides a decoding method or a decoder. In the decoding method, decoding may be performed by using the filtering method provided in this application. The decoder may perform decoding by using the filtering method provided in this application.

According to another aspect of this application, this application further provides a coding and decoding system, including the coder and the decoder in the foregoing descriptions. The coder may perform coding by using the filtering method provided in this application, and the decoder may perform decoding by using the filtering method provided in this application.

According to another aspect of this application, this application further provides a computer-readable storage medium (memory). The computer-readable storage medium stores computer instructions. When the computer instructions are read and executed by a processor of a computer device, the computer device is enabled to perform the foregoing filtering method.

The computer-readable storage medium is a memory device in a decoder or a coder, and is configured to store a program and data. The computer-readable storage medium herein may include both an internal storage medium in an electronic device and certainly an extended storage medium supported by the electronic device. The computer-readable storage medium may be configured to provide storage space, and the storage space may store an operating system of the electronic device. In addition, the storage space further stores one or more computer instructions suitable for being loaded and executed by a processor, for example, stores one or more computer instructions for performing the foregoing filtering method. These computer instructions may be one or more computer programs (including program code).

According to another aspect, this application further provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, to enable the computer to perform the filtering method provided in the foregoing embodiments.

The computer device in this application may be any device or apparatus capable of data processing, for example, including but not limited to a general-purpose computer, a dedicated computer, a computer network, or another programmable apparatus. In addition, the computer instructions in this application may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) mode.

According to another aspect of this application, this application further provides a code stream. The code stream may be a code stream decoded by using the filtering method provided in this application or a code stream generated by using the filtering method provided in this application.

A person of ordinary skill in the art may be aware that the exemplary units and process operations described with reference to the embodiments disclosed in this specification can be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application. However, the implementation still falls within the scope of this application.

The foregoing content is merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A filtering method performed by an electronic device, the method comprising:
obtaining a first to-be-filtered unit obtained through decoding, and the first to-be-filtered unit comprising a to-be-filtered picture or a to-be-filtered picture block;
determining at least one reference picture in a reference picture set, the reference picture set comprising at least one of the following: a reference picture in a reference picture list of the first to-be-filtered unit, and a to-be-filtered picture to which the first to-be-filtered unit belongs; and
filtering the first to-be-filtered unit by using a neural network filter based on first information associated with the first to-be-filtered unit and the at least one reference picture, to obtain a filtered unit.

2. The method according to claim 1, wherein the at least one reference picture forms a first reference picture combination with a smallest filtering cost among a plurality of reference picture combinations, the plurality of reference picture combinations comprise a reference picture combination obtained by combining reference pictures in the reference picture set, and the filtering cost is determined based on at least one of the following indicators: a peak signal-to-noise ratio (PSNR), a multi-scale structural similarity (MS-SSIM), and a rate distortion optimization (RDO) cost.

3. The method according to claim 1, wherein the determining at least one reference picture comprises:
decoding a code stream to obtain at least one first flag, the at least one first flag being configured for indicating the at least one reference picture in the reference picture set;
wherein, when the first to-be-filtered unit is a to-be-filtered picture, an i^{th} first flag of the at least one first flag is configured for indicating, in the reference picture set, an i^{th} reference picture of the to-be-filtered picture; and
when the first to-be-filtered unit is a to-be-filtered picture block, an i^{th} first flag of the at least one first flag is configured for indicating, in the reference picture set, a reference picture to which an i^{th} reference picture block of the to-be-filtered picture block belongs, i being a positive integer.

4. The method according to claim 3, wherein the obtaining at least one first flag comprises:
decoding the code stream to obtain a second flag; and
decoding the code stream to obtain the at least one first flag when the second flag indicates to filter the first to-be-filtered unit by using a reference picture.

5. The method according to claim 1, wherein when a quantity of the at least one reference picture is greater than 1, reference pictures among the at least one reference picture are different from each other.

6. The method according to claim 1, wherein the filtering the first to-be-filtered unit by using the neural network filter based on the first information associated with the first to-be-filtered unit and the at least one reference picture comprises:
when the first to-be-filtered unit is a to-be-filtered picture, filtering the first to-be-filtered picture by using the neural network filter and the first information associated with the first to-be-filtered unit the at least one reference picture as inputs, to obtain the filtered unit; and
when the first to-be-filtered unit is a to-be-filtered picture block, filtering the first to-be-filtered unit by using the neural network filter and by using, as inputs, the first information associated with the first to-be-filtered unit and at least one reference picture block that is in the at least one reference picture and that matches the to-be-filtered picture block, to obtain the filtered unit.

7. The method according to claim 1, wherein a reference picture block that is in any one of the at least one reference picture and that matches the to-be-filtered picture block comprises at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

8. The method according to claim 1, wherein the first information associated with the first to-be-filtered unit further comprises at least one of the following:
a prediction unit corresponding to the first to-be-filtered unit, a quantization parameter of the to-be-filtered picture to which the first to-be-filtered unit belongs, and a frame type of the to-be-filtered picture to which the first to-be-filtered unit belongs.

9. The method according to claim 1, wherein the filtering the first to-be-filtered unit by using the neural network filter based on the first information associated with the first to-be-filtered unit and the at least one reference picture comprises:
filtering at least one of a luminance component and a chrominance component of the first to-be-filtered unit by using the neural network filter based on the first information associated with the first to-be-filtered unit and the at least one reference picture, to obtain the filtered unit.

10. The method according to claim 1, wherein the determining at least one reference picture in a reference picture set comprises:
obtaining a plurality of reference picture combinations, the plurality of reference picture combinations comprising a reference picture combination obtained by combining reference pictures in the reference picture set;
determining a filtering cost of using each of the plurality of reference picture combinations; and
determining, based on the filtering cost of each reference picture combination, a reference picture comprised in a reference picture combination with a smallest filtering cost as the at least one reference picture.

11. An electronic device, comprising:
a processor suitable for executing a computer program; and
a computer-readable storage medium, the computer-readable storage medium having a computer program stored therein, and the computer program, when executed by the processor, causing the electronic device to perform a filtering method including:
obtaining a first to-be-filtered unit obtained through decoding, and the first to-be-filtered unit comprising a to-be-filtered picture or a to-be-filtered picture block;
determining at least one reference picture in a reference picture set, the reference picture set comprising at least one of the following: a reference picture in a reference picture list of the first to-be-filtered unit, and a to-be-filtered picture to which the first to-be-filtered unit belongs; and
filtering the first to-be-filtered unit by using a neural network filter based on first information associated with the first to-be-filtered unit and the at least one reference picture, to obtain a filtered unit.

12. The electronic device according to claim 11, wherein the at least one reference picture forms a first reference picture combination with a smallest filtering cost among a plurality of reference picture combinations, the plurality of reference picture combinations comprise a reference picture combination obtained by combining reference pictures in the reference picture set, and the filtering cost is determined based on at least one of the following indicators: a peak signal-to-noise ratio (PSNR), a multi-scale structural similarity (MS-SSIM), and a rate distortion optimization (RDO) cost.

13. The electronic device according to claim 11, wherein the determining at least one reference picture comprises:
decoding a code stream to obtain at least one first flag, the at least one first flag being configured for indicating the at least one reference picture in the reference picture set;
wherein, when the first to-be-filtered unit is a to-be-filtered picture, an i^{th} first flag of the at least one first flag is configured for indicating, in the reference picture set, an i^{th} reference picture of the to-be-filtered picture; and
when the first to-be-filtered unit is a to-be-filtered picture block, an i^{th} first flag of the at least one first flag is configured for indicating, in the reference picture set, a reference picture to which an i^{th} reference picture block of the to-be-filtered picture block belongs, i being a positive integer.

14. The electronic device according to claim 11, wherein when a quantity of the at least one reference picture is greater than 1, reference pictures among the at least one reference picture are different from each other.

15. The electronic device according to claim 11, wherein the filtering the first to-be-filtered unit by using the neural network filter based on the first information associated with the first to-be-filtered unit and the at least one reference picture comprises:
when the first to-be-filtered unit is a to-be-filtered picture, filtering the first to-be-filtered picture by using the neural network filter and the first information associated with the first to-be-filtered unit the at least one reference picture as inputs, to obtain the filtered unit; and
when the first to-be-filtered unit is a to-be-filtered picture block, filtering the first to-be-filtered unit by using the neural network filter and by using, as inputs, the first information associated with the first to-be-filtered unit and at least one reference picture block that is in the at least one reference picture and that matches the to-be-filtered picture block, to obtain the filtered unit.

16. The electronic device according to claim 11, wherein a reference picture block that is in any one of the at least one reference picture and that matches the to-be-filtered picture block comprises at least one of the following: a picture block that is in the any reference picture and whose position is the same as that of the first to-be-filtered unit, a picture block that is in the any reference picture and whose position is adjacent to the first to-be-filtered unit, and a picture block that is in the any reference picture and whose distance from the first to-be-filtered unit is a preset distance.

17. The electronic device according to claim 11, wherein the first information associated with the first to-be-filtered unit further comprises at least one of the following:
a prediction unit corresponding to the first to-be-filtered unit, a quantization parameter of the to-be-filtered picture to which the first to-be-filtered unit belongs, and a frame type of the to-be-filtered picture to which the first to-be-filtered unit belongs.

18. The electronic device according to claim 11, wherein the filtering the first to-be-filtered unit by using the neural network filter based on the first information associated with the first to-be-filtered unit and the at least one reference picture comprises:
filtering at least one of a luminance component and a chrominance component of the first to-be-filtered unit by using the neural network filter based on the first information associated with the first to-be-filtered unit and the at least one reference picture, to obtain the filtered unit.

19. The electronic device according to claim 11, wherein the determining at least one reference picture in a reference picture set comprises:
obtaining a plurality of reference picture combinations, the plurality of reference picture combinations comprising a reference picture combination obtained by combining reference pictures in the reference picture set;
determining a filtering cost of using each of the plurality of reference picture combinations; and
determining, based on the filtering cost of each reference picture combination, a reference picture comprised in a reference picture combination with a smallest filtering cost as the at least one reference picture.

20. A non-transitory computer-readable storage medium, configured to store a computer program, the computer program, when executed by a processor of an electronic device, enabling the electronic device to perform a filtering method including:
obtaining a first to-be-filtered unit obtained through decoding, and the first to-be-filtered unit comprising a to-be-filtered picture or a to-be-filtered picture block;
determining at least one reference picture in a reference picture set, the reference picture set comprising at least one of the following: a reference picture in a reference picture list of the first to-be-filtered unit, and a to-be-filtered picture to which the first to-be-filtered unit belongs; and
filtering the first to-be-filtered unit by using a neural network filter based on first information associated with the first to-be-filtered unit and the at least one reference picture, to obtain a filtered unit.
